(19) United States
(12) Patent Application Publication
(10) Pub. No.: US 2024/0336779 A1
(43) Pub. Date: Oct. 10, 2024

(54) DISPERSANT POLYMER AND COMPOSITION COMPRISING THE SAME

(71) Applicant: AXALTA COATING SYSTEMS IP CO., LLC, Wilmington, DE (US)

(72) Inventor: Sheau-Hwa Ma, West Chester, PA (US)

(73) Assignee: AXALTA COATING SYSTEMS IP CO., LLC, Wilmington, DE (US)

(21) Appl. No.: 18/618,119

(22) Filed: Mar. 27, 2024

Related U.S. Application Data
(60) Provisional application No. 63/493,112, filed on Mar. 30, 2023.

(51) Int. Cl. C09B 67/46; C08G 81/02

(52) U.S. Cl. CPC C09B 67/009; C08G 81/024

(57) ABSTRACT

A polymer includes the reaction product of A, B, and C and optionally D and/or E wherein: A is a polyepoxide that is: the condensation product of phenol, formaldehyde, and epichlorohydrin; the condensation product of bisphenol A, formaldehyde, and epichlorohydrin; or a combination of said condensation products; B is a polymer that is: an acrylic polymer with one or two terminal carboxylic acid groups; a polyester with one carboxylic acid group; or a combination of said polymers; and C is an anchoring compound that is: a primary amine; a secondary amine; a monocarboxylic acid; a cyclic imide; or a combination thereof; D is an alkylating agent; and E is a polyether with a terminal primary amine group. This polymer is included in a composition that further includes a compound such as a particulate solid.

### CROSS-REFERENCE TO RELATED APPLICATIONS

This application claims the benefit of U.S. Provisional Application No. 63/493,112, filed Mar. 30, 2023, the disclosure of which is hereby expressly incorporated herein by reference in its entirety.

### TECHNICAL FIELD

The present disclosure generally relates to a polymer, e.g. a dispersant polymer, and a composition that includes the polymer. More specifically, this disclosure relates to a polymer that includes the reaction product of A, B, and C, and optionally D and/or E, wherein A is a particular polyepoxide, B is a particular acrylic polymer and/or polyester, C is a particular anchoring compound, D is an alkylating agent, and E is a particular polyether.

### BACKGROUND

Polymeric materials are known which are effective for dispersing pigments in water and organic solvents and used to form pigment dispersions of uniform color that are useful in formulating waterborne and solventborne coating compositions. Such pigment dispersions are widely used, for example, in exterior coating for automobiles and trucks.

Much of the past activity concerning pigment dispersants has been focused on random copolymers, but such relatively inefficient materials are now being replaced by structured pigment dispersants. Graft copolymers are generally composed of a macromonomer grafted onto a polymer backbone and have attached to either the macromonomer, the backbone or both, one or more groups known as pigment anchoring groups which are designed to adsorb on the surface of a pigment particle and thereby anchor the polymer to the pigment surface.

While the past work indicates that graft copolymers are outstanding dispersants, the graft copolymers containing certain pigment anchoring groups can also suffer from certain significant drawbacks. For instance, the pigment anchoring groups may not selectively adsorb certain pigment types and/or can be displaced from pigment surfaces by polar solvents or other polar groups present in a coating composition. Ineffective anchoring of the dispersant to a pigment particle surface is highly undesired, since it can allow the pigment particles to flocculate, or cluster together, and can result, ultimately, in coatings of poor color quality. The graft copolymer also needs to be compatible with the binder polymers in the paint to have the best performance. Furthermore, incorporation of reactive groups so that it can be crosslinked into the binder matrix can be effective in enhancing the durability of the paint.

Accordingly, it is desirable to improve the performance of pigment dispersants, and in particular to dispersants having an increased effectiveness in dispersing a wide range of pigments, especially in coating compositions. Furthermore, other desirable features and characteristics will become apparent from the subsequent detailed description and the appended claims, taken in conjunction with this background.

### BRIEF SUMMARY

This disclosure provides a polymer that includes or is the reaction product of A, B, and C and optionally D and/or E wherein:
A is a polyepoxide that is:
   the condensation product of phenol, formaldehyde, and epichlorohydrin;
   the condensation product of bisphenol A, formaldehyde, and epichlorohydrin; or
   a combination of said condensation products;
B is a polymer that is:
   an acrylic polymer with one or two terminal carboxylic acid groups;
   a polyester with one carboxylic acid group; or
   a combination of said polymers; and
C is an anchoring compound that is:
   a primary amine;
   a secondary amine;
   a monocarboxylic acid;
   a cyclic imide; or
   a combination thereof;
D is an alkylating agent; and
E is a polyether with a terminal primary amine group.

This disclosure also provides a composition that includes a particulate compound and the aforementioned polymer.

### DETAILED DESCRIPTION

The following detailed description is merely exemplary in nature and is not intended to limit the current washing composition. Furthermore, there is no intention to be bound by any theory presented in the preceding background or the following detailed description.

Embodiments of the present disclosure are generally directed to polymers, compositions including the same, and methods for forming the same. For the sake of brevity, conventional techniques related to making polymers and such compositions may not be described in detail herein. Moreover, the various tasks and process steps described herein may be incorporated into a more comprehensive procedure or process having additional steps or functionality not described in detail herein. In particular, various steps in the manufacture of polymers and associated compositions are well-known and so, in the interest of brevity, many conventional steps will only be described briefly herein or will be omitted entirely without providing the well-known process details. In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values described herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

### Polymer

This disclosure provides a polymer, as described below. The polymer may be a single polymer but more likely is a mixture of various individual polymers that each are as described herein. Similarly, all subscript values described herein may be alternatively described as average values or discrete values, as would be understood by one of skill in the art. Moreover, throughout the specification, the terminology “polymer” and “resin” may be interchangeable.

The polymer can be a random polymer, a block polymer, or a comb polymer. The polymer can be alternatively described as a dispersant polymer. The terminology “dispersant polymer” describes that the polymer may be used for, or capable of, dispersing a compound in a composition. For example, the dispersant polymer may be used for, or capable of, dispersing a compound in a composition that includes a solvent or continuous phase, such as water, a polar solvent, or an organic solvent, as is described in greater detail below. For example, the composition may be a dispersion, emulsion, etc., wherein the continuous phase is a water or a solvent or liquid and the dispersed phase is a compound or particle. The polymer of this disclosure may make it possible to disperse the particle in the continuous phase.

The dispersant polymer may be described as a polymer that is added to a suspension, emulsion, dispersion, or colloid, to improve separation of particles therein to minimize settling and/or clumping. The polymer can be used in any type of composition, as is further described in detail below. In one embodiment, the polymer disclosed herein is a dispersant, typically a particulate solid dispersant.

The polymer can be alternatively described as a segmented copolymer. For example, the polymer may have segments of varying types based on the types of reactants used. These segments may be in a block orientation or in a comb orientation, as understood by those of skill in the art.

The polymer includes the reaction product of A, B, and C, and optionally D and/or E, which can be referred to as Reactant A, Reactant B, Reactant C, Reactant D, and Reactant E, respectively, below. In various embodiments, the polymer is or consists of the reaction product of A, B, and C, and optionally D and/or E. Even further, the polymer may consist essentially of the reaction product of A, B, and C, and optionally D and/or E, and may be free of other polymers, additives, etc. The method of forming the polymer and the reaction of these reactants is described in greater detail below.

### Reactant A

Reactant A is a polyepoxide that is the condensation product of phenol, formaldehyde, and epichlorohydrin; the condensation product of bisphenol A, formaldehyde, and epichlorohydrin; or a combination of these condensation products. In other words, (A) may be only the condensation product of phenol, formaldehyde, and epichlorohydrin. Alternatively, (A) may be only the condensation product of bisphenol A, formaldehyde, and epichlorohydrin. Alternatively, (A) may be a combination of the condensation product of phenol, formaldehyde, and epichlorohydrin and the condensation product of bisphenol A, formaldehyde, and epichlorohydrin.

Just as above, it is contemplated that the reaction may proceed by adding any one or more of phenol, formaldehyde, and epichlorohydrin, to any one or more of phenol, formaldehyde, and epichlorohydrin, in any order and in any amount. Similarly, it is contemplated that the reaction may proceed by adding any one or more of bisphenol A, formaldehyde, and epichlorohydrin, to any one or more of bisphenol A, formaldehyde, and epichlorohydrin, in any order and in any amount. In other words, all orders of addition and reaction of phenol, formaldehyde, and epichlorohydrin, and bisphenol A, formaldehyde, and epichlorohydrin, are hereby expressly contemplated.

In one embodiment, bisphenol A is combined with formaldehyde to form a mixture and then epichlorohydrin is added to the mixture. In another embodiment, bisphenol A is combined with epichlorohydrin to form a mixture and then formaldehyde is added to the mixture. The order of addition, reaction times, reaction temperatures, and reaction pressures may all be chosen by one of skill in the art.

In one embodiment, the polyepoxide has the following structure wherein n is a number, or an average, of from about 0 to about 10. In this embodiment, the polyepoxide is the condensation product of phenol and formaldehyde further reacted with epichlorohydrin to generate epoxide groups.

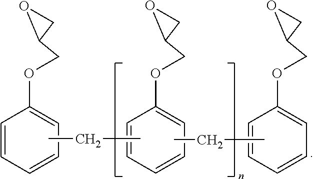

For example, as a discrete number, n can be about 0, 1, 2, 3, 4, 5, 6, 7, 8, 9, or 10. As an average number, n is greater than 0, may be less than 1, or may be as described above. In other embodiments, n, as discrete or as an average, is from about 0 to about 9, about 0 to about 8, about 0 to about 7, about 0 to about 6, about 0 to about 5, about 0 to about 4, about 0 to about 3, about 0 to about 2, or about 0 to about 1. In other embodiments, n, as discrete or as an average, is from about 0 to about 0.9, about 0 to about 0.8, about 0 to about 0.7, about 0 to about 0.6, about 0 to about 0.5, about 0 to about 0.4, about 0 to about 0.3, about 0 to about 0.2, or about 0 to about 0.1. In other embodiments, n, as discrete or as an average, is less than about 5, 4.5, 4, 3.5, 3, 2.5, 2, 1.5, or 1. In various embodiments, n, as discrete or as an average, is 0.1, 0.2, 0.3, 0.4, 0.5, 0.6, 0.7, 0.8, 0.9, 1, 1.1 . . . up to about 10. In still other embodiments, n as discrete or as an average is from about 0.1 to about 1, about 0.2 to about 0.9, about 0.3 to about 0.8, about 0.4 to about 0.7, about 0.5 to about 0.6, about 0.1 to about 2, about 0.1 to about 1.5, about 0.1 to about 0.5, about 1 to about 2, or about 1.5 to about 2. In various non-limiting embodiments, all whole and fractional values and ranges of whole and fractional values including and between each value set forth above, are hereby expressly contemplated for use herein.

In another embodiment, the polyepoxide has the following structure wherein n is a number, or an average, of from about 0 to about 5. In this embodiment, the polyepoxide is the condensation product of bisphenol A and formaldehyde further reacted with epichlorohydrin to generate epoxide groups.

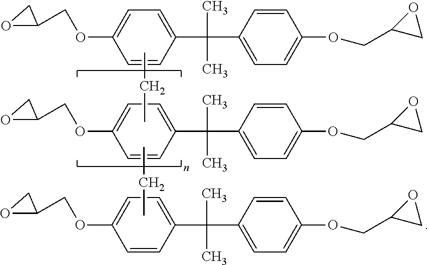

For example, as a discrete number, n can be about 0, 1, 2, 3, 4, or 5. In one embodiment, n has an average value of from greater than about 0 and up to about 5. As an average number, n is greater than 0, may be less than 1, or may be as described above. In other embodiments, n is from about 1 to about 5, about 2 to about 4, or about 3 to about 4. In other embodiments, n, as discrete or as an average, is from about 0 to about 5, about 0 to about 4, about 0 to about 3, about 0 to about 2, or about 0 to about 1. In other embodiments, n, as discrete or as an average, is from about 0 to about 0.9, about 0 to about 0.8, about 0 to about 0.7, about 0 to about 0.6, about 0 to about 0.5, about 0 to about 0.4, about 0 to about 0.3, about 0 to about 0.2, or about 0 to about 0.1. In other embodiments, n, as discrete or as an average, is less than about 5, 4.5, 4, 3.5, 3, 2.5, 2, 1.5, or 1. In various embodiments, n, as discrete or as an average, is 0.1, 0.2, 0.3, 0.4, 0.5, 0.6, 0.7, 0.8, 0.9, 1, 1.1 . . . up to about 5. In still other embodiments, n as discrete or as an average is from about 0.1 to about 1, about 0.2 to about 0.9, about 0.3 to about 0.8, about 0.4 to about 0.7, about 0.5 to about 0.6, about 0.1 to about 2, about 0.1 to about 1.5, about 0.1 to about 0.5, about 1 to about 2, or about 1.5 to about 2. In various non-limiting embodiments, all whole and fractional values and ranges of whole and fractional values including and between each value set forth above, are hereby expressly contemplated for use herein.

### Reactant B

Reactant B can be a single compound or a mixture of two or more compounds. Reactant B is typically chosen from an acrylic polymer with one or two terminal carboxylic acid groups, a polyester with one carboxylic acid group, and combinations thereof. In one embodiment, Reactant B is one or more than one acrylic polymer. In another embodiment, Reactant B is one or more than one polyester. In another embodiment, Reactant B is one or more acrylic polymers combined with one or more polyesters.

The acrylic polymer can be prepared by polymerizing an acrylic monomer mixture in the presence of a chain transfer agent having the following formula:

HS—R—(COOH)n

wherein n is 1 or 2, R has 1 to about 20 carbons and can be linear or branched, and may include other non-reactive atoms like N, S, and O. In various embodiments, R can have about 1 to about 7, about 1 to about 6, about 1 to about 5 or about 1 to about 4, carbon atoms. In various embodiments, R can have about 8 to about 20, about 9 to about 19, about 10 to about 17, about 11 to about 16, about 12 to about 15, or about 13 to about 14, carbon atoms. Alternatively, R can have any number of carbon atoms between 1 and 20 including all values therebetween. The mercaptan group and the acid group can be located on the same carbon, as in the case of thioglycolic acid, or on different carbons provided the mercaptan group is accessible to terminate the polymer chain. A non-limiting example of a chain transfer agent with two carboxylic acid groups is thiomalic acid. If the chain transfer agent is used, it may be utilized at any one or more points in synthesis, e.g. added directly to a reactor and/or added to one or more individual components which then is added to the reactor.

Alternatively, the acrylic polymer can be prepared by using a polymerization initiator that includes a carboxylic acid group. Examples include, but are not limited to, 4,4′-Azobis (4-cyanovaleric acid) (VA-501 by Wako Chemicals Europe GmbH) and 2,2′-Azobis [N-(2-carboxyethyl)-2-methylpropionamidine]tetrahydrate (VA-057 by Wako Chemicals Europe GmbH). In various embodiments, the initiator ensures the presence of one terminal carboxylic acid group. In addition, the concentration of the initiator(s) typically determines the molecular weight of the acrylic polymer.

The acrylic polymer is not particularly limited and may be any known in the art.

In various embodiments, Reactant (B) is the reaction product of one or more acrylic monomers which may be any known in the art. For example, the acrylic monomers may include one or more esters of acrylic acid and methacrylic acid. The examples include 2-ethylhexylacrylate, ethylacrylate, methylacrylate, butyl acrylate, tert-butyl acrylate, methyl methacrylate (MMA), n-butyl methacrylate (BMA), 2-ethylhexyl methacrylate, styrene, and combinations thereof. The monomer mixture may include monomers with acid groups or amine groups at a concentration such that they do not interfere with the construction of a comb like structure as they have potential to react with the epoxy groups.

Alternatively, Reactant (B) can be formed by polymerization of hydroxyl-containing monomers such as, for example and without limitation, hydroxyethyl acrylate, hydroxyethyl methacrylate, hydroxypropyl acrylate, hydroxypropyl methacrylate, hydroxybutyl acrylate, hydroxybutyl methacrylate, and hydroxyl-functional adducts thereof. Alternatively, Reactant (B) can be formed by polymerization of unsaturated acids, for example and without limitation acrylic acid, methacrylic acid, and monoesters of maleic acid at a low concentration.

In still other embodiments, Reactant (B) may be formed using one or more ethylenically unsaturated comonomers such as alkyl esters of acrylic or methacrylic acid, e.g., ethyl acrylate, butyl acrylate, 2-ethylhexyl acrylate, butyl methacrylate, isodecyl methacrylate, hydroxyethyl methacrylate, hydroxypropyl acrylate, and the like; and vinyl monomers such as unsaturated m-tetramethyl xylene isocyanate, styrene, vinyl toluene and the like. Suitable comonomers also include monomer having other functionalities, including hydroxyl, acid, and epoxide functionalities.

Alternatively, Reactant (B) may be formed using esters of α,β-ethylenically unsaturated monocarboxylic acids including 3 to 5 carbon atoms such as acrylic, methacrylic, and crotonic acids and of α,β-ethylenically unsaturated dicarboxylic acids including 4 to 6 carbon atoms; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates. Representative examples of other ethylenically unsaturated polymerizable monomers include, without limitation, such compounds as dialkyl fumaric, maleic, and itaconic esters, prepared with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, alpha-methyl styrene, vinyl toluene, tert-butyl styrene, and 2-vinyl pyrrolidone. The comonomers may be used in any combination.

In one embodiment, (B) is the acrylic polymer terminated with a thioglycolic residue. In another embodiment, (B) is the acrylic polymer terminated with a thiomalic residue.

In another embodiment, (B) is an acrylic polymer with one terminal carboxylic acid group comprising the reaction product of methyl methacrylate, butyl methacrylate, ethyl hexyl acrylate, hydroxyethyl methacrylate, and thioglycolic acid.

In another embodiment, (B) is an acrylic polymer with two terminal carboxylic acid groups comprising the reaction product of methyl methacrylate, butyl methacrylate, ethyl hexyl acrylate, hydroxyethyl methacrylate, and thiomalic acid.

In another embodiment, (B) is an acrylic polymer with one terminal carboxylic acid group comprising the reaction product of methyl methacrylate, butyl methacrylate, ethyl hexyl acrylate, and thioglycolic acid.

In another embodiment, (B) is an acrylic polymer with one terminal carboxylic acid group comprising the reaction product of methyl methacrylate, butyl acrylate, ethyl hexyl acrylate, and thioglycolic acid.

In another embodiment, (B) is an acrylic polymer with two terminal carboxylic acid groups comprising the reaction product of methyl methacrylate, butyl methacrylate, ethyl hexyl acrylate, hydroxyethyl acrylate, and thiomalic acid.

Still further, in any one or more reactions described herein, free radical initiators may be used. For example, peroxides and/or Vazo initiators can be used which are substituted azonitrile compounds that thermally decompose to generate two free radicals per molecule along with a mole of nitrogen gas. In various embodiments, the free radical initiator may be chosen from ABCN, Acetone peroxide, 4,4′-Azobis(4-cyanopentanoic acid), azobisisobutyronitrile, benzoyl peroxide, di-tert-butyl peroxide, 1,1′-dihydroxydicyclohexyl peroxide, dilauroyl peroxide, methyl ethyl ketone peroxide, potassium persulfate, tributyltin hydride, and combinations thereof. Alternatively, any peroxide in the art may be used. In still other embodiments, Reactant (B) is a polyester with one carboxylic acid group. Non-limiting examples include those described in WO2022238315A1 which is incorporated by reference herein in its entirety in various non-limiting embodiments.

In still other embodiments, the Reactant (B) is a polyester with one carboxylic acid group. A polyester with one carboxylic acid group can be prepared by homopolymerization of hydroxyacids (I) or lactones (II) or copolymerization of hydroxyacids (I) with lactones (II), as each is set forth below:

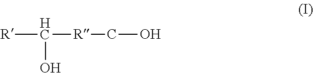

In various embodiments, one or both of R′ and R″ each independently have 0 to about 25 carbon atoms. If R′ has zero carbon atoms, then R′ is H. In other embodiments, one or both of R′ and R″ each independently have about 0 to about 20, about 1 to about 20, about 2 to about 18, about 4 to about 16 carbon atoms. In various non-limiting embodiments, all whole and fractional values and ranges of whole and fractional values including and between each value set forth above, are hereby expressly contemplated for use herein.

In various embodiments, an acid can catalyze polymerization of a cyclic structure (such as a lactone) as is shown below:

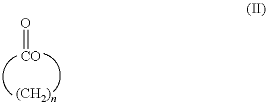

wherein n is an integer of from about 2 to about 8, e.g. about 2 to about 6, about 3 to about 5, etc. In various embodiments, a hydroxyacid such as 12-hydroxystearic acid can be used. In other embodiments, a lactone such as caprolactone can be used. One type of non-limiting reaction is described in following scheme wherein each of the reactants may be any described herein:

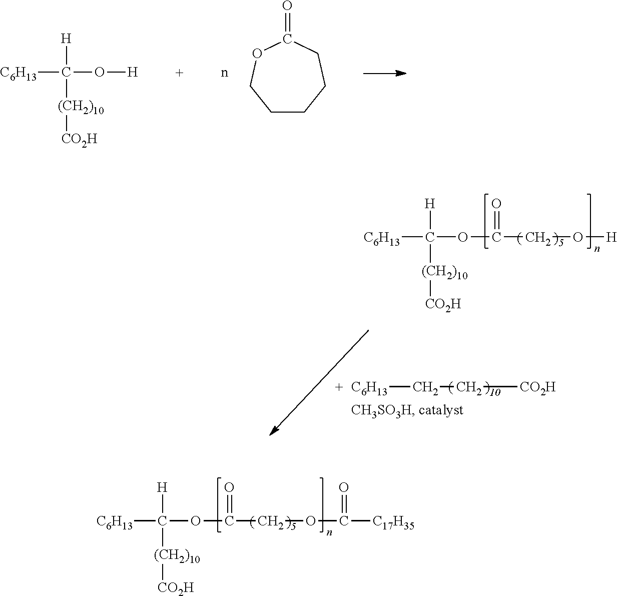

In the above reaction, the hydroxyacid reacts with a lactone to form one embodiment of reactant (B). Then in a second step reactant (B) can be further modified by capping the hydroxyl groups by an acid. This is an optional step.

The polyesters of this disclosure typically have a terminal hydroxyl group which can be used to incorporate the dispersant into a binder matrix of a paint system through reactions with an isocyanate compound or a melamine compound to improve the durability of a final coating. If so desired, the hydroxyl group can be capped using one or more mono-carboxylic acids during synthesis. Non-limiting examples of such mono-carboxylic acids include saturated and unsaturated fatty acids such as caprylic acid, lauric acid, linoleic acid, stearic acid, and combinations thereof. By varying a weight or molar ratio of the hydroxyacids and lactones, and the use of mono-carboxylic acids, polyesters of different compositions can be prepared for a desired solubility and compatibility to suit a particular paint system. Using a mixture of multiple mono-carboxylic acid polyesters in dispersant synthesis is contemplated in one embodiment of this disclosure.

In the alternative, reaction of a di-hydroxy acid such as 2,2′-bis(hydroxymethyl)propionic with a lactone such as caprolactone can provide a synthetic route to place the carboxylic acid group in the middle of the polyester chain, as is shown below in one non-limiting example.

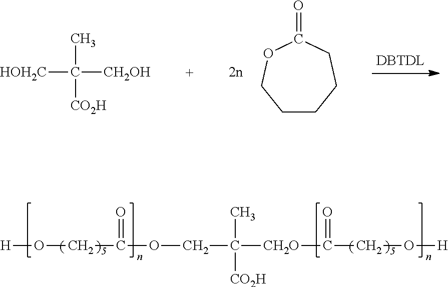

It is also contemplated that the polyester can be prepared by a standard esterification process known to one skilled in the art. Methanesulfonic acid, toluene sulfonic acid and dimethyl tin dilaurate are useful catalysts for the polymerization.

In various embodiments, the polyester has a weight average molecular weight (Mw) of from about 500 to about 20,000, about 2,000 to about 18,000, about 4,000 to about 16,000, about 6,000 to about 14,000, about 8,000 to about 12,000, about 10,000 to about 12,000, about 1,000 to about 10,000, about 2,000 to about 9,000, about 3,000 to about 8,000, about 4,000 to about 7,000, or about 5,000 to about 6,000, g/mol, as measured by the size exclusion chromatography method with the polystyrene or polymethyl methacrylate as the standard. In various non-limiting embodiments, all whole and fractional values and ranges of whole and fractional values including and between each value set forth above, are hereby expressly contemplated for use herein.

### Reactant C

Reactant C is an anchoring compound that is a primary amine, secondary amine, a monocarboxylic acid, a cyclic imide, or a combination thereof. The primary amine, secondary amine, monocarboxylic acid, and cyclic imide are not particularly limited and may be any known in the art. The primary amine can be linear, branched, cyclic, or aromatic. The secondary amine can also be linear, branched, cyclic, or aromatic. Similarly, the monocarboxylic acid can be linear, branched, cyclic, or aromatic.

The primary amine has a single organic substituent (alkyl or aryl) bound to a nitrogen together with two hydrogen atoms. In one embodiment, the primary amine is chosen from methylamine, ethylamine, propylamine, phenylamine, and combinations thereof.

Primary amines typically have one organic substituent (alkyl, aryl or both) bound to a nitrogen atom together with two hydrogen atoms and are capable of reacting with two epoxy groups. This property gives them the ability to extend a polymer chain by reacting with the epoxy group of two separate polyepoxide chains of the Reactant A and build molecular weight in the final product, if so desired.

In one embodiment, the primary amine is chosen from N-benzyl amine, 1-(3-aminopropyl)imidazole, cyclohexyl amine, and combinations thereof. In another embodiment, the primary amine is chosen from methylamine, ethylamine, propylamine, isopropylamine, butylamine, ethanolamine, and combinations thereof. In one embodiment, the primary amine is N-benzyl amine.

In other embodiments, the primary amine has the formula R′-NH₂ and/or the secondary amine has the formula R′R″—NH, wherein each of R′ and R″ can independently be an aliphatic or aromatic group and can have from 1 to about 25 carbon atoms. Each of R′ and R″ can independently be saturated or unsaturated. Each of R′ and R″ can independently be linear, branched, cyclic, or aromatic. In various embodiments, one or both of R′ and R″ each independently have 1 to about 20 carbon atoms. In various embodiments, one or both of R′ and R″ each independently have about 1 to about 7, about 2 to about 6, about 3 to about 5 or about 4 to about 5, carbon atoms. In other embodiments, one or both of R′ and R″ each independently have about 8 to about 20, about 9 to about 19, about 10 to about 17, about 11 to about 16, about 12 to about 15, or about 13 to about 14, carbon atoms. In other embodiments, one or both of R′ and R″ each independently have about 7 carbon atoms (e.g. a phenyl ring and a methylene unit). In other embodiments, one or both of R′ and R″ each independently have about 8 to about 20 carbon atoms. In various non-limiting embodiments, all whole and fractional values and ranges of whole and fractional values including and between each value set forth above, are hereby expressly contemplated for use herein.

Secondary amines typically have two organic substituents (alkyl, aryl or both) bound to a nitrogen atom together with one hydrogen. In one embodiment, the secondary amine is chosen from dimethylamine, diethylamine, dipropylamine, diphenylamine, and combinations thereof.

In one embodiment, the secondary amine is chosen from pyrrolidine, piperidine, oxazolidines, morpholine, dicyclohexyl amine, and combinations thereof. In another embodiment, the secondary amine is chosen from diisopropylamine, N,N′-dimethyl-1,3-diamine, dimethyl amine, diethanolamine, and combinations thereof. In another embodiment, the secondary amine is chosen from N-benzylmethylamine, N-methylaniline, and combinations thereof.

The monocarboxylic acid may be any compound having a single carboxyl (COOH) group. In various embodiments, the monocarboxylic acid has the formula R¹COOH wherein R¹ is a linear, branched, or cyclic group, such as a hydrocarbyl group, having from 2 to 25 carbon atoms. In other embodiments, R¹ is a group having from about 2 to about 25, about 2 to about 20, about 2 to about 15, or about 2, 3, 4, 5, 6, 7, 8, 9, 10, 11, 12, 13, 14, 15, 16, 17, 18, 19, or 20. In other embodiments, R¹ is a group having from about 2 to about 6, about 3 to about 5, about 3 to about 4, or 2, 3, 4, 5, or 6, carbon atoms. In other embodiments, R¹ is a group having 6 carbon atoms. In another embodiment, the monocarboxylic acid has the formula R¹COOH wherein R¹ is an aliphatic group having from about 8 to about 24 carbon atoms. In other embodiments, R¹ can be aliphatic, aromatic, or aralkyl. The monocarboxylic acid can be saturated or unsaturated. In various non-limiting embodiments, all whole and fractional values and ranges of whole and fractional values including and between each value set forth above, are hereby expressly contemplated for use herein.

In one embodiment, the monocarboxylic acid is aromatic. In one embodiment, the monocarboxylic acid is a substituted or unsubstituted benzoic acid. In another embodiment, the monocarboxylic acid is nitrobenzoic acid, e.g. 2-, 3-, or 4-, nitrobenzoic acid. In another embodiment, the monocarboxylic acid is chosen from caprylic acid, capric acid, palmitic acid, stearic acid, isostearic acid, oleic acid, linoleic acid, behenic acid, and combinations thereof.

Referring now to the cyclic imide, a cyclic imide is an imide that has two acyl groups bound to a nitrogen in which the two carbonyl carbons are connected by a 5 atom cyclic structure. The cyclic imide is not particularly limited in this disclosure and may be any known in the art. For example, the cyclic imide may be chosen from 2,3-dibromomaleimide, maleimide, α,α-dimethyl-β-methylsuccinimide, 3,4,5,6-tetrachlorophthalimide, 4,5-dichlorophthalimide, phthalimide, cis-1,2,3,6-tetrahydrophthalimide, pyromellitic diimide, 3-maleimidopropionic acid, α-methyl-α-phenylsuccinimide, 1,8-naphthalimide, and combinations thereof. In one embodiment, the cyclic imide is phthalimide.

In one embodiment, the (C) anchoring compound is a monocarboxylic acid that has the formula R¹COOH wherein R¹ is an aliphatic group having from about 6 to 8 carbon atoms or an aromatic group having about 6 to about 8 carbon atoms.

In another embodiment, the (C) anchoring compound is chosen from nitrobenzoic acid, benzyl amine, methylbenzyl amine, phthalimide, and combinations thereof.

### Reactant D

As described above, the polymer may be formed using reactant D or may be formed in the absence (without) D. For example, the polymer may be formed by reacting a tertiary amine with reactant D which is an alkylating agent. In such an embodiment, the tertiary amine is itself the reaction product of reactant C (i.e., a secondary amine anchoring compound) and reactant A (the polyepoxide). This reaction would form one or more quaternary ammonium groups on the polymer. Reactant B could then also participate in this reaction as understood by those of skill in the art.

In one embodiment, the reaction is as follows wherein (A+B+C) is first reacted then followed by optional reaction with D. In another embodiment, the reaction is as follows wherein (A+B+C+E) is first reacted then followed by optional reaction with D.

For example, moles of A (i.e., epoxy groups on A) may be approximately equal to the moles of reactive groups of (B+C) if B has one acid group, ± up to about 10 mol %, such as 1, 2, 3, 4, 5, 6, 7, 8, 9, or 10 mol %. Alternatively, moles of A (i.e., epoxy groups on A) may be approximately equal to the moles of reactive groups of (2B+C) if B has two acid groups, ± up to about 10 mol %, such as 1, 2, 3, 4, 5, 6, 7, 8, 9, or 10 mol %. Similarly, C may be utilized when one of the reactants is a primary amine, e.g. as follows: (B+2C) or (2B+2C). If C is a secondary amine then C can react once with the epoxy groups of A, e.g. (B+C) or (2B+C). In still other examples, moles of A (i.e., epoxy groups on A) may be approximately equal to the moles of reactive groups of [(B+C)+2(E)] or [(2B+C)+2(E)] or [(2B+2C)+2(E)] or [(B+2C)+2(E)], each ± up to about 10 mol %, such as 1, 2, 3, 4, 5, 6, 7, 8, 9, or 10 mol %. In the above, 2B and 2C indicate that B is capable of reacting twice with the epoxy groups of A and C is capable of reacting twice with the epoxy groups of A. Moreover, 2E indicates that E is capable of reacting twice with the epoxy groups of A. It is to be understood that all molar ratio combinations of A, B, C, and E are hereby expressly contemplated for use in various non-limiting embodiments and can be calculated by the skilled person.

Typically, if too many epoxide groups are utilized in the polymer, then the polymer is unstable and is not a suitable dispersant and would not be effective. If too many groups associated with B and/or C are utilized, then the cost for production increases. However, performance may or may not increase/decrease when excess amounts of B and C are used. In various non-limiting embodiments, all whole and fractional values and ranges of whole and fractional values including and between each value set forth above, are hereby expressly contemplated for use herein.

Reactant D is an alkylating agent and is not particularly limited. In various embodiments, the alkylating agent may be an electrophilic alkylating agent. For example, in a Menshutkin reaction, a tertiary amine is converted into a quaternary ammonium salt by reaction with an alkyl halide. The alkyl halide may be any known in the art.

In various embodiments, reactant D is chosen from benzyl chloride, dimethyl sulfate, methyl-p-toluenesulfonate, and combinations thereof. In one embodiment, reactant D is benzyl chloride. In another embodiment, reactant D is dimethyl sulfate. In a further embodiment, reactant D is methyl-p-toluenesulfonate. In another embodiment, reactant D is chosen from dialkyl sulfates such as dimethyl sulfate, diethyl sulfate, and combinations thereof. In another embodiment, reactant D is chosen from substituted alkyl sulfonates, unsubstituted alkyl sulfonates, arylalkyl sulfonates, and combinations thereof.

### Reactant E

As described above, the polymer may be formed using reactant E or may be formed in the absence of (without) E, which is or includes a polyether with a terminal primary amine group. Any such polyether known in the art may be used. In various embodiments, Reactant (E) may be described as a commercially available compound known as a Jeffamine®. In one embodiment, the Jeffamine has the following structure:

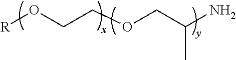

wherein R be linear, branched, cyclic, or aromatic. In various embodiments, R has 1 to about 20 carbon atoms. In other embodiments, R has about 8 to about 20, about 9 to about 19, about 10 to about 17, about 11 to about 16, about 12 to about 15, or about 13 to about 14, carbon atoms. In other embodiments, R has about 1, 2, 3, 4, 5, 6, 7, 8, 9, 10, 11, 12, 13, 14, 15, 16, 17, 18, 19, or 20, carbon atoms. In addition, each of x and y may independently be any number of from about 1 to about 75, about 1 to about 70, about 1 to about 65, about 1 to about 60, about 1 to about 55, about 1 to about 50, about 1 to about 45, about 1 to about 40, about 1 to about 35, about 1 to about 30, about 1 to about 25, about 1 to about 20, about 1 to about 15, about 1 to about 10, about 1 to about 5, or any value therebetween. It is to be understood that x or y may be zero so long as both x and y are not both zero. In various non-limiting embodiments, all whole and fractional values and ranges of whole and fractional values including and between each value set forth above, are hereby expressly contemplated for use herein.

In one embodiment, Jeffamine M-2005 Polymer has the structure as set forth below wherein R is methyl, x is 6, and y is 29:

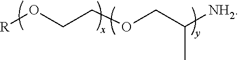

In another embodiment, Jeffamine M-2070 Polymer has the structure as set forth below wherein R is methyl, x is 33, and y is 10:

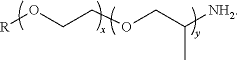

In another embodiment, Jeffamine M-3085 Polymer has the structure as set forth below wherein R is methyl, x is 58, and y is 8:

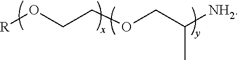

### Additional Embodiments

In various embodiments, the polymer may be described as having an anchoring group, e.g. formed from use of Reactant C which is the anchoring compound which may or may not be aromatic. In other words, the anchoring group may be described as the group in the final polymer that is formed from the anchoring compound that is utilized during synthesis of the polymer. The anchoring group on the polymer may be chosen from (1) aromatic ester groups, (2) aromatic amine groups, (3) cationic quaternary ammonium groups, (4) a cyclic imide group that may be attached to an aromatic group, or (5) any mixtures thereof. In various embodiments, the concentration of the pigment anchoring group in the polymer is at least about 1% by weight, based on the total weight of the polymer. At lower concentrations, there may not be sufficient interaction with the pigment to avoid flocculation, particularly in more polar solvents. The typical concentration is between about 2 and about 40% by weight. However, at higher concentrations, generally above 20% by weight, low polarity solvents may not be satisfactory solvents for the dispersants.

The aromatic ester anchoring groups, in particular, can be attached as pendant groups by reacting epoxy functional groups with an aromatic carboxylic acid. The aromatic carboxylic acids useful herein may be unsubstituted or may contain substituents, such as, e.g., nitro groups, hydroxy, ester, acryloxy, amide, nitrile, halogen, haloalkyl, alkoxy, and the like. Typical aromatic carboxylic acids are benzoic acid, 2-nitrobenzoic acid, 3-nitrobenzoic acid, 4-nitrobenzoic acid, 3,5-dinitrobenzoic acid, 1-naphthoic acid, 3-chlorobenzoic acid, 4-biphenyl carboxylic acid, n-phthaloyl glycine, 4-sulfamido benzoic acid, and the like. All isomer of the aforementioned compounds are hereby expressly contemplated for use herein in various non-limiting embodiments.

The aromatic amine anchoring groups can be added to the polymer by reacting epoxy functional groups with a primary aromatic and/or secondary aromatic amine. An example of an aromatic primary amine is benzylamine. In various embodiments, the primary and/or secondary aromatic amines may be unsubstituted or may contain substituents such as, e.g., hydroxy, ester, acyloxy, amide, nitrile, halogen, haloalkyl, alkoxy, and the like. Typical secondary aromatic amines include N-benzyl methylamine, N-benzylethanolamine, N,N-dibenzylamine, 2-(2-methylaminoethyl) pyridine, 1-phenylpiperazine. 1-benzyl piperazine, 3-(3-pyridylmethylamine) propionitrile, and the like. Alternatively, the pendant aromatic amine groups may be introduced by using instead a precursor compound containing both a tertiary aromatic amine and a carboxylic acid functional group in the esterification reaction described above. Useful examples of such compounds include nicotinic acid, picolinic acid, isonicotinic acid, and the like.

The polymer of this disclosure may also include cationic quaternary ammonium groups as the pigment anchoring group. These anchoring groups can be, and typically are, attached to the polymer by contacting tertiary amine functional groups built into the backbone with an alkylation agent, as first introduced above. Total alkylation can be at least about 10, 20, 30, 40, 50, 60, 70, 80, 90% of the tertiary amine moieties. These cationic precursor units are typically converted to the quaternary state after the formation of the basic copolymer structure by bringing the cationic precursor unit into contact with conventional alkylation agents, such as aralkyl halides, alkyl halides, alkyl toluene sulfonate, or trialkyl phosphates halides or any one described above. In other embodiments, monohalides are utilized. In further embodiments, benzylchloride and/or dimethylsulfate can be used. In other embodiments, dialkyl sulfates are utilized such as dimethyl sulfate, diethyl sulfate, and combinations thereof. In various non-limiting embodiments, all whole and fractional values and ranges of whole and fractional values including and between each value set forth above, are hereby expressly contemplated for use herein.

In still other non-limiting embodiments, the pigment anchoring group may be any one or more of those described in U.S. Pat. Nos. 6,472,463; 6,495,618; 6,451,950; 5,424,364; 6,037,414; and/or 4,656,226, each of which is expressly incorporated herein by reference in its entirety in various non-limiting embodiments.

### Method of Forming the Polymer

The polymer includes the reaction product of A, B, and C, and optionally D and/or E, which can be referred to as Reactant A, Reactant B, Reactant C, Reactant D, and Reactant E, respectively, below. For example, the polymer is typically formed from the reaction of A, B, and C and optionally D and/or E. It is contemplated that the reaction may proceed by adding any one or more of A, B, C, D and/or E, to any one or more of A, B, C, D, and/or E in any order and in any amount, as understood by those of skill in the art. In other words, all orders of addition and reaction of A, B, C, D, and E are hereby expressly contemplated. In one embodiment, A, B, and C are all combined together at the same time.

In one embodiment, A is combined with B and then Cis combined with the combination of A and B. Alternatively, A and C are combined and then B is combined with the combination of A and C. Alternatively, B and C are combined and then A is combined with the combination of B and C.

D and E are each expressly contemplated to be optional. Accordingly, D and/or E may be used or the polymer may be free from any reaction with D and/or E. If D and/or E is used, it may be included in any of the reaction combinations above or may be used separately. In one embodiment, A, B C, and E are first combined and reacted and then D may be utilized. In various embodiments, the polymer has one or more quaternary ammonium groups that are the result of reacting a tertiary amine with D the alkylating agent wherein the tertiary amine is itself the reaction product of C the secondary amine anchoring compound and A the polyepoxide, as described in greater detail below.

The polymer may be, include, consist essentially of, or consist of, the reaction product of A, B, and C. Alternatively, the polymer may be, include, consist essentially of, or consist of, the reaction product of A, B, C, and D and/or E. Alternatively, The polymer may be, include, consist essentially of, or consist of, the reaction product of A, B, and C, to the exclusion of D and/or E.

The polymer may be formed by any method known in the art involving the reaction product of A, B, and C, and optionally D and/or E. The order of addition, reaction times, reaction temperatures, and reaction pressures may all be chosen by one of skill in the art.

In various embodiments, the reaction conditions are as follows:
Reaction Time: about 1 to about 8, about 2 to about 7, about 3 to about 6, about 4 to about 5, about 2 to about 6, or about 2 to about 4, hours.
Reaction Temperature: about 70° C. to about 200° C., about 80° C. to about 180° C., or about 100° C. to about 150° C.
Reaction Pressure: typically atmospheric or less than atmospheric pressure.
   In various non-limiting embodiments, all whole and fractional values and ranges of whole and fractional values including and between each value set forth above, are hereby expressly contemplated for use herein.

Typical solvents that can be used to form the polymer, in any one or more reactions described above, include alcohols, such as methanol, ethanol, n-propanol, and isopropanol; ketones, such as acetone, butanone, pentanone, hexanone, and methyl ethyl ketone; alkyl esters of acetic, propionic, and butyric acids, such as ethyl acetate, butyl acetate, and amyl acetate; ethers, such as tetrahydrofuran, diethyl ether, and ethylene glycol and polyethylene glycol monoalkyl and dialkyl ethers such as cellosolves and carbitols; and, glycols such as ethylene glycol and propylene glycol; cyclic carbonates, and mixtures thereof. In other embodiments, propylene carbonate is used as the solvent.

### Composition

This disclosure also provides a composition that includes the aforementioned polymer. The amount of polymer in the composition is not particularly limited. However, in various embodiments, the polymer is present in an amount of from about 0.01 to about 50, about 0.25 to about 50, about 0.5 to about 50, about 0.25 to about 35, about 0.5 to about 30, about 5 to about 30, about 5 to about 25, about 5 to about 20, about 5 to about 15, about 5 to about 10, about 10 to about 20, about 10 to about 15, about 15 to about 20, about 15 to about 30, about 15 to about 25, or about 15, weight percent based on a total weight of the composition. In various embodiments, the polymer is present in an amount of from about 0.01 to about 5, about 0.05 to about 5, about 0.1 to about 5, about 1 to about 5, about 0.01 to about 0.1, about 0.02 to about 0.09, about 0.03 to about 0.08, about 0.04 to about 0.07, about 0.05 to about 0.06, about 0.1 to about 1, about 0.2 to about 0.9, about 0.3 to about 0.8, about 0.4 to about 0.7, about 0.5 to about 0.6, about 1.1 to about 3, about 1.2 to about 2.9, about 1.3 to about 2.8, about 1.4 to about 2.7, about 1.5 to about 2.6, about 1.6 to about 2.5, about 1.7 to about 2.4, about 1.8 to about 2.3, about 1.9 to about 2.2, about 2.0 to about 2.1, weight percent based on a total weight of the composition. Notably, this weight basis can be either a solid weight basis (e.g. without solvent) or a liquid weight basis, e.g. when the composition includes a solvent. In some embodiments, the weight can be up to about 55, about 60, about 65 or about 70, weight percent based on solid weight basis. In various non-limiting embodiments, all whole and fractional values and ranges of whole and fractional values including and between each value set forth above, are hereby expressly contemplated for use herein.

The composition may also include a compound in addition to the polymer. This compound may be a particulate solid or may be a liquid, such as an oil. In various embodiments, the particulate solid may be any inorganic or organic solid material which is substantially insoluble in a solvent. In one embodiment, the particulate solid is a pigment or filler.

In one embodiment, the particulate solid is an organic pigment from any of the recognized classes of pigments described, for example, in the Third Edition of the Colour Index (1971) and subsequent revisions of, and supplements thereto, under the chapter headed “Pigments”. Carbon black, although strictly inorganic, behaves more like an organic pigment in its dispersing properties. Non-limiting examples of suitable particulate solids are pigments for solvent inks; pigments, extenders and fillers for paints and plastics materials; disperse dyes; optical brightening agents, and combinations thereof. In various embodiments, suitable inorganic solids include extenders and fillers such as talc, kaolin, silica, barytes and chalk, flame-retardant fillers such as alumina trihydrate, or magnesium hydroxide; particulate ceramic materials such as alumina, silica, zirconia, titania, silicon nitride, boron nitride, silicon carbide, boron carbide, mixed silicon-aluminium nitrides and metal titanates; particulate magnetic materials such as the magnetic oxides of transition metals, especially iron and chromium, e.g., gamma-Fe₂O₃, Fe₃O₄, and cobalt-doped iron oxides, calcium oxide, ferrites, especially barium ferrites; and metal particles, especially metallic iron, nickel, cobalt, copper and alloys thereof.

In one embodiment, the pigment may be a phthalocyanine, or mixtures thereof. The phthalocyanine may for instance include phthalocyanine green pigment, phthalocyanaine blue pigment, etc. In other embodiments, the pigment is carbon black. In another embodiment, the pigment is an anti-corrosive pigment. In other embodiments, suitable inorganic pigments include, for example, titanium dioxide, iron oxides of various colors, zinc oxide, carbon black, talc, china clay, barytes, carbonates, silicates and combinations thereof. In further embodiments, suitable organic pigments include, for example, quinacridones, phthalocyanines, perylenes, azo pigments, indanthrones, carbazoles, isoindolinones, isoindolones, thioindigio reds, and benzimidazolinones; and metallic flakes such as aluminum flake, pearlescent flakes, and combinations thereof.

In other embodiments, the composition may include film-forming resins for use in various applications such as paints and inks. Examples of such resins include polyamides, such as Versamid™ and Wolfamid™, and cellulose ethers, such as ethyl cellulose and ethyl hydroxyethyl cellulose, nitrocellulose and cellulose acetate butyrate resins, including mixtures thereof. Examples of paint resins include short oil alkyd/melamine-formaldehyde, polyester/melamine-formaldehyde, thermosetting acrylic/melamine-formaldehyde, long oil alkyd, polyether polyols and multi-media resins such as acrylic and urea/aldehyde.

The composition may alternatively include one or more polyols, that is to say, a compound with two or more hydroxy groups. In one embodiment, polyols include alpha-omega diols or alpha-omega diol oxyalkylene.

In still other embodiments, the composition can include, or be free of, an additional acrylic or polyester resin in an amount that can be chosen by the skilled person.

The solvent may be or include water, an aqueous solvent, or an organic solvent. In one embodiment, the solvent may be a combination of water and water miscible solvents. The aqueous solvent may be described as any polar solvent known in the art. For example, the polar solvent may be an alcohol such as ethanol or methanol, butanol, isobutanol, acetone, methyl ethyl ketone, isopropanol, n-propanol, acetonitrile, DMSO (dimethyl sulfoxide), DMF (dimethyl formamide), ether alcohols, butyl cellosolve, dipropyleneglycol monomethylether, or combinations thereof.

In other embodiments, the solvent may be or include an organic solvent which may be polar or non-polar. For example, the solvent may be a polar organic liquid such as an ether, especially lower alkyl ethers, ester, ketone, glycol, alcohol, amide, or combinations thereof. In one embodiment, polar organic liquids include dialkyl ketones, alkyl esters of alkane carboxylic acids and alkanols, especially such liquids including up to, and including, a total of 6 or 8 carbon atoms. As examples of the polar organic liquids include dialkyl and cycloalkyl ketones, such as acetone, methyl ethyl ketone, diethyl ketone, di-isopropyl ketone, methyl isobutyl ketone, di-isobutyl ketone, methyl ketone, methyl n-amyl ketone and cyclohexanone; alkyl esters such as methyl acetate, ethyl acetate, isopropyl acetate, butyl acetate, ethyl formate, methyl propionate, methoxypropyl acetate and ethyl butyrate; glycols and glycol esters and ethers, such as ethylene glycol, 2-ethoxyethanol, 3-methoxypropylpropanol, 3-ethoxypropylpropanol, 2-butoxyethyl acetate, 3-methoxypropyl acetate, 3-ethoxypropyl acetate and 2-ethoxyethyl acetate; alcohols such as methanol, ethanol, n-propanol, isopropanol, n-butanol and isobutanol and dialkyl and cyclic ethers such as diethyl ether and tetrahydrofuran. In one embodiment, solvents are alcohols, and esters of alkane carboxylic acids. The polar organic liquid may include methanol, ethanol, n-propanol, isopropanol, n-butanol and isobutanol, or mixtures thereof. In one embodiment, the solvent is water.

In one embodiment, non-polar organic liquids are compounds including aliphatic groups, aromatic groups or mixtures thereof. The non-polar organic liquids include non-halogenated aromatic hydrocarbons (e.g., toluene and xylene), halogenated aromatic hydrocarbons (e.g., chlorobenzene, dichlorobenzene, chlorotoluene), non-halogenated aliphatic hydrocarbons (e.g., linear and branched aliphatic hydrocarbons including six or more carbon atoms both fully and partially saturated), halogenated aliphatic hydrocarbons (e.g., dichloromethane, carbon tetrachloride, chloroform, trichloroethane) and natural non-polar organics (e.g., vegetable oil, sunflower oil, linseed oil, terpenes and glycerides).

The organic liquid may be chosen such that it reacts via UV cure. For example, the organic liquid may be an acrylate containing liquid.

In one embodiment, the organic liquid includes at least 0.1% by weight, or 1% by weight or more of a polar organic liquid based on the total organic liquid. The organic liquid optionally further includes water. In one embodiment, the organic liquid is free of water. When the organic liquid includes water, the amount of water present in various embodiments is not greater than 10%, or not greater than 5%, or not greater than 1% by weight based on the total amount of organic liquid plus water. In other words, compositions that include more than about 10 wt. % of water are not typically considered to be solvent borne. In various non-limiting embodiments, all whole and fractional values and ranges of whole and fractional values including and between each value set forth above, are hereby expressly contemplated for use herein.

In various embodiments, the composition includes water present in an amount of at least about 10, 15, 20, 25, 30, 35, 40, 45, 50, 55, 60, 65, or 70 weight percent based on a total weight of the composition. In another embodiment, the composition includes a non-aqueous solvent in an amount of at least 10, 15, 20, 25, 30, 35, 40, 45, 50, 55, 60, 65, or 70 weight percent based on a total weight of the composition. In various non-limiting embodiments, all whole and fractional values and ranges of whole and fractional values including and between each value set forth above, are hereby expressly contemplated for use herein.

If desired, the compositions may include, or be free of, other ingredients, for example, resins binders, fluidizing agents, anti-sedimentation agents, plasticizers, surfactants, anti-foam agents, rheology modifiers, levelling agents, gloss modifiers, preservatives, pH adjustors such as organic amines, biocides, and the like, and combinations thereof.

In various embodiments, the composition typically includes from about 1 to about 95% by weight of the compound, e.g. the particulate solid, the precise quantity depending on the nature of the compound and the relative densities of the compound and a solvent. For example, a composition in which the compound is a particulate solid such as an organic material or organic pigment, in one embodiment includes from about 1 to about 60, about 5 to about 55, about 10 to about 50, about 15 to about 45, about 20 to about 40, about 25 to about 35, or about 35 to about 30, percent by weight of the particulate solid whereas a composition in which the particulate solid is an inorganic material, such as an inorganic pigment, filler or extender and in another embodiment includes from about 20 to about 90, about 25 to about 85, about 30 to about 80, about 35 to about 75, about 40 to about 70, about 45 to about 65, about 50 to about 60, or about 55 to about 60, % by weight of the particulate solid based on the total weight of composition. In various embodiments, the composition includes the compound in an amount of from about 4 to about 16, about 6 to about 14, about 8 to about 12, or about 10 to about 12, % by weight of the particulate solid based on the total weight of composition. In various embodiments, the composition includes the compound in an amount of from about 1 to about 95, about 10 to about 90, about 15 to about 85, about 20 to about 80, about 25 to about 75, about 30 to about 70, about 35 to about 65, about 40 to about 60, about 45 to about 55, or about 50, % by weight based on a total weight of the composition. In various non-limiting embodiments, all whole and fractional values and ranges of whole and fractional values including and between each value set forth above, are hereby expressly contemplated for use herein.

The composition may be described as a coating composition, which may be any type known in the art. For example, the composition may be further defined as a paint or ink including the compound such as the particulate solid, an organic liquid, a binder and the polymer disclosed herein.

### Method of Forming the Composition

The composition may be prepared by any of the conventional methods known in the art. For example, the compound such as the particulate solid, any solvent, and the polymer may be combined in any order and then be subjected to a mechanical treatment to reduce the particles of the particulate solid to an appropriate size, for example, by ball milling, 2-roll or 3-roll milling, bead milling, gravel milling or plastic milling until the dispersion is formed. Alternatively, the compound such as the particulate solid may be treated to reduce its particle size independently or in admixture with either the solvent or the polymer and/or the other ingredient or ingredients then being added and the mixture being agitated to provide the composition.

In one embodiment, the composition is a liquid dispersion. The dispersion may be a nano-dispersion (typically with a mean particle size of 100 nm or less), or a micro-dispersion (typically with a mean particle size of greater than 100 nm to 3 microns). In one embodiment, such dispersion compositions include: (a) 0.5 to 70 parts of a particulate solid, (b) 0.5 to 40 parts of the polymer, and (c) 30 to 99 parts of the aforementioned solvent; wherein all parts are by weight and the amounts (a)+(b)+(c)=100. In one embodiment, component a) includes 0.5 to 70 parts of a pigment and such dispersions are useful as liquid inks, paints and mill-bases. In one embodiment, component a) includes 0.5 to 40 parts of a pigment and such dispersions are useful as liquid inks. If a composition is required including a particulate solid and a polymer disclosed herein in dry form, the solvent is typically volatile so that it may be readily removed from the particulate solid by a simple separation means such as evaporation. In various non-limiting embodiments, all whole and fractional values and ranges of whole and fractional values including and between each value set forth above, are hereby expressly contemplated for use herein.

If a dry composition includes the polymer disclosed herein and the particulate solid, it typically includes at least 0.2%, at least 0.5% or at least 1.0% of the polymer based on weight of the particulate solid. In one embodiment, the dry composition includes not greater than 99.9%, not greater than 50%, not greater than 20%, or not greater than 10% by weight of the polymer disclosed herein based on the weight of the particulate solid. In one embodiment, the polymer disclosed herein is present at 0.6 wt. % to 8 wt. %. In various non-limiting embodiments, all whole and fractional values and ranges of whole and fractional values including and between each value set forth above, are hereby expressly contemplated for use herein.

### Dispersion

This disclosure also provides a dispersion that includes water and/or a solvent, a particulate solid (such as a pigment), and the aforementioned polymer. The dispersion may be waterborne or solvent borne, as understood by those of skill in the art. For example, even in water borne compositions, a small amount of a non-polar solvent may be included. Similarly, in a solvent borne composition, a small amount of water and/or a polar solvent may be included. Accordingly, it is contemplated that the terminology waterborne and solvent borne may be strictly interpreted or may be more loosely interpreted to allow for small amounts of other solvents, in various non-limiting embodiments.

It is also contemplated that the color pigment, i.e., a pigment that provides color, may be any described herein or known in the art. This pigment may be combined with any other additives or pigments described herein or known in the art. Alternatively, this color pigment may be substituted for any pigment or additive described herein or known in the art, in various non-limiting embodiments.

In one embodiment, the dispersion is solvent borne and includes the non-polar solvent. In this embodiment, (A) has the structure as follows wherein n is an average of about 2.4:

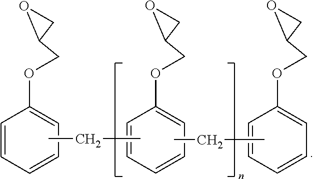

Moreover, (B) may be any one or more of the acrylic and/or the polyester or combinations thereof as described above having the requisite one or two carboxylic acid groups; and (C) may be n-benzylmethyl amine and/or p-nitro benzoic acid. (D) is optional and may be, for example, methyl-p-toluene sulfonate. (E) is also optional and may be any described herein, e.g. one or more of the Jeffamines described above.

In another embodiment, the dispersion is waterborne and includes water. In this embodiment, (A) has the structure as follows wherein n is an average of about 1.5:

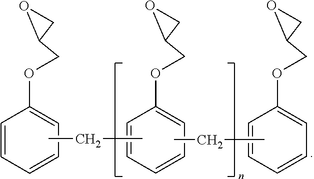

Moreover, (B) may be any one or more of the acrylic and/or the polyester or combinations thereof as described above having the requisite one or two carboxylic acid groups; and (C) may be n-benzylmethyl amine and/or p-nitro benzoic acid. (D) is optional and may be, for example, methyl-p-toluene sulfonate. (E) is also optional and may be any described herein, e.g. one or more of the Jeffamines described above.

In another embodiment, the dispersion is solventborne. In this embodiment, (A) has the structure as follows wherein n is an average of about 0.5:

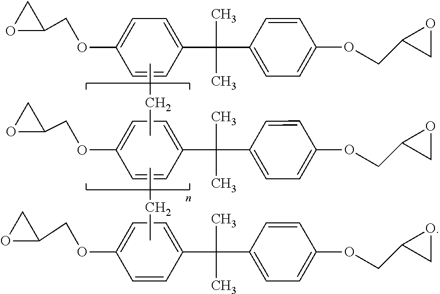

Moreover, (B) may be any one or more of the acrylic and/or the polyester or combinations thereof as described above having the requisite one or two carboxylic acid groups. In addition, (C) may be n-benzylmethyl amine and/or p-nitro benzoic acid. (D) is optional and may be, for example, methyl-p-toluene sulfonate. (E) is also optional and may be any described herein.

In another embodiment, the dispersion is waterborne and includes water. In this embodiment, (A) has the structure as follows wherein n is an average of about 2.4:

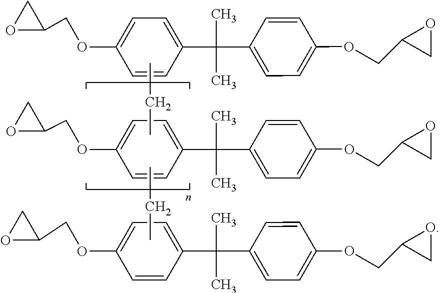

Moreover, (B) may be any one or more of the acrylic and/or the polyester or combinations thereof as described above having the requisite one or two carboxylic acid groups. In addition, (C) may be n-benzylmethyl amine and/or p-nitro benzoic acid and (D) may be methyl-p-toluene sulfonate. (E) is also optional and may be any described herein.

The amount of polymer in the dispersion is not particularly limited. However, in various embodiments, the polymer is present in an amount of from about 0.01 to about 50, about 0.25 to about 50, about 0.5 to about 50, about 0.25 to about 35, about 0.5 to about 30, about 5 to about 30, about 5 to about 25, about 5 to about 20, about 5 to about 15, about 5 to about 10, about 10 to about 20, about 10 to about 15, about 15 to about 20, about 15 to about 30, about 15 to about 25, or about 15, weight percent based on a total weight of the dispersion. Notably, this weight basis can be either a solid weight basis (e.g. without solvent) or a liquid weight basis. In various non-limiting embodiments, all whole and fractional values and ranges of whole and fractional values including and between each value set forth above, are hereby expressly contemplated for use herein.

In various embodiments, the dispersion includes water or the non-polar solvent in an amount of at least about 10, 15, 20, 25, 30, 35, 40, 45, 50, 55, 60, 65, or 70 weight percent based on a total weight of the composition. In various non-limiting embodiments, all whole and fractional values and ranges of whole and fractional values including and between each value set forth above, are hereby expressly contemplated for use herein.

In various embodiments, the dispersion includes the color pigment in an amount of from about 2 to about 95, about 10 to about 90, about 15 to about 85, about 20 to about 80, about 25 to about 75, about 30 to about 70, about 35 to about 65, about 40 to about 60, about 45 to about 55, or about 50, % by weight based on a total weight of the dispersion.

The instant dispersion may include one or more additives or pigments as described above in one or more amounts as described above.

### Additional Embodiments

In one embodiment, the (A) polyepoxide may be, but is not limited to, BNE 200, and the (C) anchoring compound may be, but is not limited to, nitrobenzoic acid.

In another embodiment, the (A) polyepoxide may be, but is not limited to, BNE 200 and the (C) anchoring compound may be, but is not limited to, benzyl amine.

In another embodiment, the (A) polyepoxide may be, but is not limited to, BNE 200, and the (C) anchoring compound may be, but is not limited to, a combination of nitrobenzoic acid and benzyl amine.

In another embodiment, the (A) polyepoxide may be, but is not limited to, BNE 200, and the (C) anchoring compound may be, but is not limited to, methylbenzyl amine.

In another embodiment, the (A) polyepoxide may be, but is not limited to, DEN 440 and the (C) anchoring compound may be, but is not limited to, nitrobenzoic acid.

In another embodiment, the (A) polyepoxide may be, but is not limited to, Epon 164 and the (C) anchoring compound may be, but is not limited to, nitrobenzoic acid.

In another embodiment, the (A) polyepoxide may be, but is not limited to, BNE 200 and the (C) anchoring compound may be, but is not limited to, nitrobenzoic acid.

In another embodiment, the (A) polyepoxide may be, but is not limited to, PNE 177H) and the (C) anchoring compound may be, but is not limited to, nitrobenzoic acid.

In another embodiment, the (A) polyepoxide may be, but is not limited to, PNE 177H) and the (C) anchoring compound may be, but is not limited to, nitrobenzoic acid and polyether monoamine (e.g. Jeffamine 2005).

### EXAMPLES

Examples 1-22 below describe preparation of various polymers of this disclosure. Examples 5 and 6 below describe comparative polymers. Example 7 provides an evaluation of the polymers of Examples 1-4 and the comparative polymers of Examples 5 and 6 as pigment dispersants.

### Example 1

### Preparation of MMA/BMA/2-EHA/HEA/TGA Copolymer, 40/34.5/10/12/3.5% by Weight

Example 1 describes the preparation of an acrylic copolymer with one terminal carboxylic acid group. A 5-liter flask was equipped with a thermometer, stirrer, additional funnels, heating mantel, reflux condenser and a means of maintaining a nitrogen blanket over the reactants. The flask was held under nitrogen positive pressure and the following ingredients were employed (Table 1).

TABLE 1

| | Weight |
|---|---|
| | (gram) |
| Portion 1 | |
| Propylene glycol monomethyl ether (PM acetate, Dowanol | 272 |
| DPM, Dow Chemical) | |
| Portion 2 | |
| Methyl methacrylate (MMA) | 320 |
| N-Butyl methacrylate (BMA) | 276 |
| 2-Ethylhexyl acrylate (2-EHA) | 80 |
| 2-Hydroxyethyl acrylate (HEA) | 96 |
| Thioglycolic acid (TGA, Sigma-Aldridge Chemicals Company) | 28 |
| Portion 3 | |
| Dicumyl peroxide | 5.5 |
| PM acetate | 100 |
| Portion 4 | |
| PM acetate | 20 |
| Portion 5 | |
| PM acetate | 20 |
| Total | 1,217.5 |

Portion 1 was charged to the flask. The solvent was heated to reflux temperature and refluxed for about 10 minutes. Portion 2 was fed to the flask over 120 minutes. The Portion 3 was simultaneously fed to the flask over 150 minutes. The Portion 4 was used to rinse the Portion 2 into the flask at the end of the feed. The Portion 5 was used to rinse the Portion 3 at the end of the feed. The reaction mixture was held at reflux temperature throughout the course of feeds and the reaction mixture was refluxed for another 60 minutes. The finished product was cooled and filtered.

The resulting polymer solution was a clear polymer solution and had a measured solid content of 63.85% and a Gardner-Holtz viscosity of W+1/2. The polymer had a 5,259 Mw and a 2,791 Mn based on gel permeation chromatography using polymethylmethacrylate as standard.

### Example 2

### Preparation of MMA/BMA/2-EHA/HEA/TMA Copolymer, 40/35/10/12/3% by Weight

Example 2 describes the preparation of an acrylic copolymer similar to the one described in Example 1 but with a different composition and two terminal carboxylic acid groups. The resin solution was prepared using the same procedure described in Example 1 with ingredients listed in Table 2.

TABLE 2

| | Weight |
|---|---|
| | (gram) |
| Portion 1 | |
| PM acetate | 560 |
| Portion 2 | |
| MMA | 760 |
| BMA | 665 |
| 2-EHA | 190 |
| HEA | 228 |
| Thiomalic acid (TMA, Sigma-Aldridge Chemicals Company) | 57 |
| Acetone | 250 |
| Portion 3 | |
| 2,2′-Azobis(methylbutyronitrile) (Vazo ® 67) | 12.5 |
| PM acetate | 150 |
| Portion 4 | |
| PM acetate | 25 |
| Portion 5 | |
| PM acetate | 25 |
| Total | 2,922.5 |

The powder of TMA was pre-dissolved in acetone before it was mixed with the rest of Portion 2. Portion 1 and 25% of Portion 2 were charged to the flask. The mixture was heated to reflux temperature and refluxed for about 10 minutes. At reflux, 20% of the Portion 3 was fed into the flask over 10 minutes. The reaction mixture was held at reflux temperature for another 10 minutes. The remaining 75% of Portion 2 and the remaining 80% of Portion 3 were simultaneously fed to the flask over 120 minutes. The Portion 4 was used to rinse the Portion 2 into the flask at the end of the feed. The Portion 5 was used to rinse the Portion 3 at the end of the feed. The reaction mixture was held at reflux temperature throughout the course of feeds and the reaction mixture was refluxed for another 60 minutes. The finished product was cooled and filtered.

The resulting polymer solution was a clear solution and had a measured solid content of 63.09% and a Gardner-Holtz viscosity of Y+3/4. The polymer had a 9,668 Mw and a 4,976 Mn based on gel permeation chromatography using polymethylmethacrylate as standard.

### Example 3

### Preparation of MMA/BMA/2-EHA/TGA Copolymer, 45/37.5/15/2.5% by Weight

Example 3 describes the preparation of an acrylic copolymer similar to the one described in Example 1 but with a different composition and molecular weight. The resin solution was prepared using the same procedure described in Example 1 with ingredients listed in Table 3.

TABLE 3

| | Weight |
|---|---|
| | (gram) |
| Portion 1 | |
| PM acetate | 800 |
| Portion 2 | |
| MMA | 1,008 |
| BMA | 840 |
| 2-EHA | 336 |
| TGA | 56 |
| Portion 3 | |
| Dicumyl peroxide | 14 |
| PM acetate | 280 |
| Portion 4 | |
| PM acetate | 50 |
| Portion 5 | |
| PM acetate | 50 |
| Total | 3,434 |

The resulting polymer solution was a clear polymer solution and had a measured solid content of 62.50% and a Gardner-Holtz viscosity of W+3/4. The polymer had a 6,591 Mw and a 2,860 Mn based on gel permeation chromatography using polymethylmethacrylate as standard.

### Example 4

### Preparation of MMA/BA/2-EHA/TGA Copolymer, 64/20/12/4% by Weight

Example 4 describes the preparation of an acrylic copolymer similar to the one described in Example 1 but with a different composition and molecular weight. The resin solution was prepared using the same procedure described in Example 1 with ingredients listed in Table 4. An extra initiator add Portion 4 was used to ensure good conversion from monomers to polymer.

TABLE 4

| | Weight |
|---|---|
| | (gram) |
| Portion 1 | |
| Butyl acetate | 800 |
| Portion 2 | |
| MMA | 1,433.6 |
| N-Butyl acrylate (BA) | 448 |
| 2-EHA | 268.8 |
| TGA | 89.6 |
| Portion 3 | |
| t-Butyl peroctoate | 12 |
| Butyl acetate | 280 |
| Portion 4 | |
| t-Butyl peroctoate | 0.6 |
| Butyl acetate | 14 |
| Portion 5 | |
| Butyl acetate | 40 |
| Portion 6 | |
| Butyl acetate | 40 |
| Total | 3,426.6 |

The resulting polymer solution was a clear polymer solution and had a measured solid content of 62.34% and a Gardner-Holtz viscosity of O+1/2. The polymer had a Mw of 4,495 and a Mn of 2,241 based on gel permeation chromatography using polymethylmethacrylate as standard.

### Example 5

### Preparation of MMA/BMA/2-EHA/HEA/TMA Copolymer, 40/37/10/10/3% by Weight

Example 5 describes the preparation of an acrylic copolymer similar to the one described in Example 2 but with a different composition and two terminal carboxylic acid groups. The resin solution was prepared using the same procedure described in Example 2 with ingredients listed in Table 5.

TABLE 5

| | Weight |
|---|---|
| | (gram) |
| Portion 1 | |
| PM acetate | 672 |
| Portion 2 | |
| MMA | 912 |
| BMA | 843.6 |
| 2-EHA | 228 |
| HEA | 228 |
| TMA | 68.4 |
| Acetone | 250 |
| Portion 3 | |
| Vazo ® 67 | 15 |
| PM acetate | 180 |
| Portion 4 | |
| PM acetate | 30 |
| Portion 5 | |
| PM acetate | 30 |
| Total | 3,457 |

The resulting polymer solution was a clear solution and had a measured solid content of 62.81% and a Gardner-Holtz viscosity of Z+1/2. The polymer had a 9,387 Mw and a 4,817 Mn based on gel permeation chromatography using polymethylmethacrylate as standard.

### Example 6

### Preparation of MMA/BMA/2-EHA/HEA/TMA Copolymer, 40/37.5/8/12/2.5% by Weight

Example 6 describes the preparation of an acrylic copolymer similar to the one described in Example 2 but with a different composition and molecular weight, and two terminal carboxylic acid groups. The resin solution was prepared using the same procedure described in Example 2 with ingredients listed in Table 6. Two extra initiator adds were used to ensure conversion of monomer to polymer.

TABLE 6

| | Weight |
|---|---|
| | (gram) |
| Portion 1 | |
| PM acetate | 868.424 |
| Portion 2 | |
| MMA | 912 |
| BMA | 855 |
| 2-EHA | 182.4 |
| HEA | 273.6 |
| TMA | 57 |
| Acetone | 250 |
| Portion 3 | |
| Vazo ® 67 | 16.5 |
| PM acetate | 200 |
| Portion 4 | |
| Vazo ® 67 | 0.75 |
| PM acetate | 9.09 |
| Portion 5 | |
| Vazo ® 67 | 0.75 |
| PM acetate | 9.09 |
| Portion 6 | |
| PM acetate | 25 |
| Portion 7 | |
| PM acetate | 25 |
| Total | 3,684.60 |

The resulting polymer solution was a clear solution and had a measured solid content of 60.59% and a Gardner-Holtz viscosity of Y+2/3. The polymer had a 11,526 Mw and a 5,240 Mn based on gel permeation chromatography using polymethylmethacrylate as standard.

### Example 7

### Preparation of MMA/BA/2-EHA/TGA Copolymer, 64.5/20/12/3.5% by Weight

Example 7 describes the preparation of an acrylic copolymer similar to the one described in Example 1 but with a different composition and molecular weight. The resin solution was prepared using the same procedure described in Example 1 with ingredients listed in Table 7. An extra initiator add Portion 7 was used to ensure good conversion from monomers to polymer.

TABLE 7

| | Weight |
|---|---|
| | (gram) |
| Portion 1 | |
| Butyl acetate | 800 |
| Portion 2 | |
| MMA | 1,444.8 |
| N-Butyl acrylate (BA) | 448 |
| 2-EHA | 268.8 |
| TGA | 78.4 |
| Portion 3 | |
| t-Butyl peroctoate | 12 |
| Butyl acetate | 280 |
| Portion 4 | |
| t-Butyl peroctoate | 0.6 |
| Butyl acetate | 14 |
| Portion 5 | |
| Butyl acetate | 40 |
| Portion 6 | |
| Butyl acetate | 40 |
| Total | 3,426.6 |

The resulting polymer solution was a clear polymer solution and had a measured solid content of 64.86% and a Gardner-Holtz viscosity of V+1/4. The polymer had a Mw of 4,891 and a Mn of 2,356 based on gel permeation chromatography using polymethylmethacrylate as standard.

### Example 8

### Preparation of 12-HAS/Caprolactone Copolymer, 38.51/61.49% by Weight

Example 8 describes the preparation of a polyester with a terminal carboxylic acid group on one end and a hydroxyl group on the other end. The ingredients of Portion 1 were charged into a reactor equipped with an agitator, thermocouple, water separator, and a reflux condenser under a nitrogen blanket.

The reaction mixture was heated as the temperature increased gradually from 150° C. to 167° C. over 4 hours and 45 minutes as 44.7 grams of water was removed.

TABLE 8

| | Weight |
|---|---|
| | (gram) |
| Portion 1 | |
| 12-Hydroxy stearic acid (12-HAS) | 965 |
| Caprolactone | 1541 |
| Methanesulfonic acid | 2.5 |
| Toluene | 300 |
| Total | 2808.5 |

The resulting polymer solution had a measured solid content of 88.95% and an acid number of 15.57 based on the polymer solids. The polymer had a Mn of 6,480 based on gel permeation chromatography method using polystyrene as the standard.

### Example 9

### Preparation of Caprolactone/BHPA Copolymer, 89.49/10.51% by Weight

Example 9 describes the preparation of a polyester with a single carboxylic acid group in the middle of the polyester chain and the hydroxyl groups on both ends. This allows for the creation of a branching structure for the stabilizing arms on the final dispersant. The ingredients of Portion 1 were charged into a reactor equipped with an agitator, thermocouple, water separator, and a reflux condenser under a nitrogen blanket.

The reaction mixture was heated at 150° C. for 4 hours to completely polymerize caprolactone. When cooled the product was an opaque white solids.

TABLE 9

| | Weight |
|---|---|
| Portion 1 | (gram) |
| Caprolactone | 1141.5 |
| 2,2′-Bis(hydroxymethyl)propionic acid (BHPA) | 134.1 |
| Dibutyl tin dilaurate (10% solution in xylene) | 1.7 |
| Total | 1,277.3 |

The resulting polymer solid had a measured content of 9933% and an acid number of 43 based on the polymer solids. The polymer had a Mn of 3,370 based on gel permeation chromatography method using polystyrene as the standard.

### Example 10

### Preparation of BNE200(p-NBA)//MMA/BMA/2-EHA/HEA/TGA Graft Copolymer, 17.42(9.15)//73.43% by Weight

Example 10 describes the preparation of a graft copolymer with hydrophobic, solvent soluble polyacrylic polymer on the stabilizing arms and hydrophobic aromatic groups, and nitrobenzoate groups on the backbone that can be utilized to disperse and stabilize pigments in a solvent borne coating composition. A 1-liter flask was equipped with a thermometer, stirrer, additional funnel, heating mantel, reflux condenser and a means of maintaining a nitrogen blanket over the reactants. The flask was held under nitrogen positive pressure and the following ingredients were employed (Table 10).

TABLE 10

| | Weight |
|---|---|
| | (gram) |
| Portion 1 | |
| Acrylic polymer of Example 1 | 200 |
| BNE 200 (pellets, Chang Chun Plastics | 30.83 |
| Co., Ltd., Taiwan) | |
| p-Nitro benzoic acid (p-NBA) | 16.19 |
| PM acetate | 50 |
| Portion 2 | |
| Trimethyl benzyl ammonium hydroxide | 1.93 |
| (40% solution in methanol, Aldrich) | |
| Total | 298.95 |

Portion 1 mixture was charged to the flask. The mixture was heated with agitation under the nitrogen blanket until the ingredients were completely dissolved. The Portion 2 was added slowly through the additional funnel. The reaction mixture was heated to 120° C. and held at the temperature for 3 hours. The finished product was cooled and filtered.

The resulting polymer solution was a light yellow clear polymer solution and had a solid content of about 59.85%, an acid number of 0.295, and a Gardner-Holtz viscosity of Y+1/2. The polymer had a 18,451 Mw and a 4,757 Mn based on gel permeation chromatography using polymethylmethacrylate as standard.

### Example 11

### Preparation of BNE 200(BzA)//MMA/BMA/2-EHA/TGA Graft Copolymer, 17.45(5.69)//76.86% by Weight

Example 11 describes the preparation of a graft copolymer with hydrophobic solvent soluble acrylic polymer as the stabilizing arms and hydrophobic aromatic groups, and amine groups on the backbone that can be utilized to disperse and stabilize pigments in a solvent borne coating composition. The Portion 1 mixture was heated to 120° C. with agitation. Portion 2 was added and dissolved quickly. The batch temperature was raised to reflux and held at the temperature for 3 hours. The finished product was cooled and filtered.

TABLE 11

| | Weight |
|---|---|
| | (gram) |
| Portion 1 | |
| Acrylic polymer of Example 3 | 320 |
| Benzyl amine (BzA) | 15.45 |
| Trimethyl benzyl ammonium hydroxide | 2.48 |
| (40% solution in methanol, Aldrich) | |
| PM acetate | 100 |
| Portion 2 | |
| BNE 200 (pellets, Chang Chun Plastics | 47.38 |
| Co., Ltd., Taiwan) | |
| Total | 485.31 |

The resulting polymer solution was a light yellow slightly polymer solution and had a solid content of about 56.16%, an acid number of 0.71, and a Gardner-Holtz viscosity of Y+3/4. The polymer had a 64,860 Mw and a 4,936 Mn based on gel permeation chromatography using polymethylmethacrylate as standard.

### Example 12

Preparation of BNE 200(p-NBA/BzA)//MMA/BMA/2-EHA/TGA Graft Copolymer, 17.11(5.44/2.09)//75.36% by Weight

Example 12 describes the preparation of a graft copolymer similar to the one described in Example 10 and 11 but with a different composition. It has hydrophobic solvent soluble stabilizing arms and hydrophobic aromatic groups, nitrobenzoate groups, and amine groups on the backbone that can be utilized to disperse and stabilize pigments in a solvent borne coating composition. The resin solution was prepared using the same procedure described in Example 2 with ingredients listed in Table 12.

TABLE 12

| | Weight |
|---|---|
| | (gram) |
| Portion 1 | |
| Acrylic polymer of Example 3 | 320 |
| N-Benzyl amine (BzA) | 5.79 |
| p-Nitrobenzoic acid | 15.06 |
| PM acetate | 100 |
| Trimethyl benzyl ammonium hydroxide | 2.48 |
| (40% solution in methanol, Aldrich) | |
| Portion 2 | |
| BNE 200 (pellets, Chang Chun Plastics | 47.38 |
| Co., Ltd., Taiwan) | |
| Total | 490.71 |

The resulting polymer solution was a light yellow polymer solution and had a solid content of about 55.37%, an acid number of 0.87, and a Gardner-Holtz viscosity of W+1/4. The polymer had a 22,871 Mw and a 8,783 Mn based on gel permeation chromatography using polymethylmethacrylate as standard.

### Example 13

### Preparation of BNE200(MBzA)//MMA/BA/2-EHA/TGA Graft Copolymer, 18.13(7.04)//74.83% by Weight

Example 13 describes the preparation of a graft copolymer similar to the one described in Example 10 with a different composition. It has hydrophobic solvent soluble stabilizing arms and hydrophobic aromatic groups and amine groups on the backbone that can be utilized to disperse and stabilize pigments in a solvent borne coating composition. The resin solution was prepared using the same procedure described in Example 9 with ingredients listed in Table 13.

TABLE 13

| | Weight |
|---|---|
| | (gram) |
| Portion 1 | |
| Acrylic polymer of Example 4 | 320 |
| N-Methyl benzyl amine (MBzA) | 19.69 |
| PM acetate | 100 |
| Trimethyl benzyl ammonium hydroxide | 2.65 |
| (40% solution in methanol, Aldrich) | |
| Portion 2 | |
| BNE200 (pellet, Chang Chun Plastics | 50.67 |
| Co., Ltd., Taiwan) | |
| Total | 493.01 |

The resulting polymer solution was a light yellow slightly clear polymer solution and had a solid content of about 56.38%, an acid number of 0.57, and a Gardner-Holtz viscosity of K+1/2. The polymer had a 11,300 Mw and a 3,514 Mn based on gel permeation chromatography using polymethylmethacrylate as standard.

### Example 14

### Preparation of BNE 200(MBzA/MTS)//MMA/BA/2-EHA/TGA Graft Copolymer, 16.85(6.55/7.04)//69.56% by Weight

Example 14 describes the preparation of a graft copolymer similar to the one described in Example 13 except that there are additional quaternary ammonium groups on the backbone to interact with pigment surfaces. The pre-polymer solution was prepared using the same procedure described in Example 13 with ingredients listed in Table 14. The Portion 3 was added to the pre-polymer solution and refluxed for 2 hours. The finished product was cooled and filtered.

TABLE 14

| | Weight |
|---|---|
| | (gram) |
| Portion 1 | |
| Acrylic polymer of Example 4 | 320 |
| N-Methyl benzyl amine (MBzA) | 19.69 |
| PM acetate | 110 |
| Trimethyl benzyl ammonium hydroxide | 2.65 |
| (40% solution in methanol, Aldrich) | |
| Portion 2 | |
| BNE200 (pellet, Chang Chun Plastics | 50.67 |
| Co., Ltd., Taiwan) | |
| Portion 3 | |
| Methyl p-toluene sulfonate (MTS) | 21.19 |
| PM acetate | 10 |
| Total | 534.20 |

The resulting polymer solution was a light yellow clear polymer solution and had a solid content of about 56.48%, an acid number of 0.97, and a Gardner-Holtz viscosity of X+1/4. The pre-polymer before reaction with MTS had a 11,671 Mw and a 3,447 Mn based on gel permeation chromatography using polymethylmethacrylate as standard.

### Example 15

Preparation of DEN 440(p-NBA)//MMA/BMA/2-EHA/HEA/TMA Graft Copolymer, 16.82(9.07)//74.11% by Weight

Example 15 describes the preparation of a graft copolymer similar to the one described in Example 10 but with a different composition. It has hydrophobic solvent soluble stabilizing arms and hydrophobic aromatic groups, and nitrobenzoate groups on the backbone that can be utilized to disperse and stabilize pigments in a solvent borne coating composition.

TABLE 15

| | Weight |
|---|---|
| Portion 1 | (gram) |
| Acrylic polymer of Example 5 | 320 |
| DEN 440 (72% solution in Methyl ethyl | 5.79 |
| ketone, by Olin Epoxy) | |
| p-Nitrobenzoic acid | 15.06 |
| PM acetate | 100 |
| Trimethyl benzyl ammonium hydroxide | 2.48 |
| (40% solution in methanol, Aldrich) | |
| Total | 490.71 |

Portion 1 mixture was charged to the flask. The mixture was heated to reflux temperature with agitation under the nitrogen blanket until the ingredients were completely dissolved. Some solvent was distilled off so that the batch temperature would reach 120° C. The reaction mixture was held at the temperature for 3 hours. The resulting polymer solution was a light yellow polymer solution and had a solid content of about 58.7%, an acid number of 0.414, and a Gardner-Holtz viscosity of Z3+1/4. The polymer had a 38,770 Mw and a 5,631 Mn based on gel permeation chromatography using polymethylmethacrylate as standard.

### Example 16

Preparation of Epon 164(p-NBA)//MMA/BMA/2-EHA/HEA/TMA Graft Copolymer, 19.73(10.32)//69.95% by Weight

Example 16 describes the preparation of a graft copolymer similar to the one described in Example 10 but with a different composition. It has hydrophobic solvent soluble stabilizing arms and hydrophobic aromatic groups, and nitrobenzoate groups on the backbone that can be utilized to disperse and stabilize pigments in a solvent borne coating composition.

TABLE 16

| | Weight |
|---|---|
| | (gram) |
| Portion 1 | |
| Acrylic polymer of Example 2 | 200 |
| p-Nitrobenzoic acid | 19.17 |
| PM acetate | 70 |
| Epon 164 (100% solids by Hexion Chemical | 36.67 |
| Company) | |
| Portion 2 | |
| Trimethyl benzyl ammonium hydroxide (40% | 3.44 |
| solution in methanol, Aldrich) | |
| Total | 329.28 |

Portion 1 mixture was charged to the flask. The mixture was heated to reflux temperature with agitation under the nitrogen blanket. The batch temperature was held at reflux for about 15 minutes until the ingredients were completely dissolved. Portion 2 was added very slowly through an additional funnel. Some solvent was distilled off so that the batch temperature would reach 120° C. The reaction mixture was held at the temperature for 3 hours. The resulting polymer solution was a light yellow clear polymer solution and had a solid content of about 58.96%, an acid number of 0.612, and a Gardner-Holtz viscosity of Z3+1/4. The polymer had a 34,417 Mw and a 5,815 Mn based on gel permeation chromatography using polymethylmethacrylate as standard.

### Example 17

Preparation of BNE 200(p-NBA)//MMA/BMA/2-EHA/HEA/TMA Graft Copolymer, 15.98(8.70)//75.32% by Weight

Example 17 describes the preparation of a graft copolymer similar to the one described in Example 10 but with a different composition. It has hydrophobic solvent soluble acrylic polymer as the stabilizing arms and hydrophobic aromatic groups, and nitrobenzoate groups on the backbone that can be utilized to disperse and stabilize pigments in a solvent borne coating composition.

TABLE 17

| | Weight |
|---|---|
| | (gram) |
| Portion 1 | |
| Acrylic polymer of Example 6 | 250 |
| p-Nitrobenzoic acid (p-NBA) | 17.50 |
| Propylene carbonate | 30 |
| PM acetate | 20 |
| Portion 2 | |
| BNE 200 (pellets, Chang Chun Plastics | 32.13 |
| Co., Ltd., Taiwan) | |
| Portion 3 | 38 |
| PM acetate | |
| Portion 4 | |
| Trimethyl benzyl ammonium hydroxide | 2.35 |
| (40% solution in methanol, Aldrich) | |
| PM acetate | 15 |
| Total | 404.98 |

Portion 1 mixture was charged to the flask. The mixture was heated to reflux temperature with agitation under the nitrogen blanket. The batch temperature was held at reflux for about 15 minutes until the ingredients were completely dissolved. Portion 2 was added quickly followed with the Portion 3 rinse. The reaction mixture was heated to reflux temperature again and Portion 4 was added very slowly through an additional funnel. Some solvent was distilled off so that the batch temperature would reach 120° C. The reaction mixture was held at the temperature for 3 hours. The resulting polymer solution was a light yellow slightly polymer solution and had a solid content of about 56.73%, an acid number of 0.523, and a Gardner-Holtz viscosity of X. The polymer had a 19,420 Mw and a 3,891 Mn based on gel permeation chromatography using polymethylmethacrylate as standard.

### Example 18

### Preparation of PNE 177H(p-NBA)//MMA/BMA/2-EHA/HEA/TMA Graft Copolymer, 16.82(9.10)//74.08% by Weight

Example 18 describes the preparation of a graft copolymer similar to the one described in Example 15 but with a different composition. It has hydrophobic solvent soluble stabilizing arms and hydrophobic aromatic groups, and nitrobenzoate groups on the backbone that can be utilized to disperse and stabilize pigments in a solvent borne coating composition.

The polymer was prepared using the procedure described in Example 15 with ingredients listed in Table 18.

TABLE 18

| | Weight |
|---|---|
| Portion 1 | (gram) |
| Acrylic polymer of Example 5 | 200 |
| PNE 177H (pellets, Chang Chun Plastics | 29.94 |
| Co., Ltd., Taiwan) | |
| p-Nitrobenzoic acid | 16.21 |
| PM acetate | 55 |
| Trimethyl benzyl ammonium hydroxide | 2.19 |
| (40% solution in methanol, Aldrich) | |
| Total | 303.34 |

The resulting polymer solution was a light yellow polymer solution and had a solid content of about 59.58%, an acid number of 0.647, and a Gardner-Holtz viscosity of Z2+3/4. The polymer had a 25,095 Mw and a 4,279 Mn based on gel permeation chromatography using polymethylmethacrylate as standard.

### Example 19

### Preparation of PNE 177H(p-NBA)//MMA/BMA/2-EHA/HEA/TMA/Jeffamine 2005 Graft Copolymer, 17.27(9.09)//69.09/4.55% by Weight

Example 19 describes the preparation of a graft copolymer similar to the one described in Example 15 but with a different composition. It has acrylic and polyether hydrophobic solvent soluble stabilizing arms and hydrophobic aromatic groups, and nitrobenzoate groups on the backbone that can be utilized to disperse and stabilize pigments in a solvent borne coating composition. The polymer was prepared using the procedure described in Example 15 with ingredients listed in Table 19.

TABLE 19

| | Weight |
|---|---|
| Portion 1 | (gram) |
| Acrylic polymer of Example 5 | 200 |
| Jeffamine 2005 (100%, Huntsman Corporation) | 8.68 |
| PNE 177H (pellets, Chang Chun Plastics Co., | 32.98 |
| Ltd., Taiwan) | |
| p-Nitrobenzoic acid | 17.36 |
| PM acetate | 50 |
| Trimethyl benzyl ammonium hydroxide (40% | 1.72 |
| solution in methanol, Aldrich) | |
| Total | 310.74 |

The resulting polymer solution was a light yellow polymer solution and had a solid content of about 62.04%, an acid number of 0.297, and a Gardner-Holtz viscosity of Z3+1/2. The polymer had a 22,834 Mw and a 3,951 Mn based on gel permeation chromatography using polymethylmethacrylate as standard.

### Example 20

Preparation of PNE 177(p-NBA)//MMA/BA/2-EHA/TGA/Jeffamine 2005 (MTS) Graft Copolymer, 20.09(10.55)//28.14/39.46 (1.76) % by Weight

Example 20 describes the preparation of a graft copolymer similar to the one described in Example 19 except that there are additional quaternary ammonium groups on the backbone to interact with pigment surfaces. The pre-polymer solution was prepared using the same procedure described in Example 11 with ingredients listed in Table 20. The Portion 3 was added to the pre-polymer solution and refluxed for 2 hours. The finished product was cooled and filtered.

TABLE 20

| | Weight |
|---|---|
| | (gram) |
| Portion 1 | |
| Acrylic polymer of Example 7 | 576 |
| Jeffamine 2005 (100%, Huntsman Corporation) | 528 |
| p-Nitrobenzoic acid (p-NBA) | 141.22 |
| Propylene carbonate | 480 |
| Trimethyl benzyl ammonium hydroxide (40% | 15.61 |
| solution in methanol, Aldrich) | |
| Portion 2 | |
| PNE 177 (80% solution in xylene, Chang | 336 |
| Chun Plastics Co., Ltd., Taiwan) | |
| Portion 3 | |
| Methyl p-toluene sulfonate (MTS) | 23.52 |
| PM acetate | 48 |
| Total | 2,148.35 |

The resulting polymer solution was a light yellow clear polymer solution and had a solid content of about 68.64%, and a Gardner-Holtz viscosity of U+1/2. The pre-polymer before reaction with MTS had a 20,127 Mw and a 7,154 Mn based on gel permeation chromatography using polymethylmethacrylate as standard

### Comparative Example 1

### Preparation of PNE177(p-NBA)//Jeffamine M-2005 Segmented Copolymer, 17.41(3.30)//79.29% by Weight

Comparative Example 1 describes the preparation of a graft copolymer with polyether stabilizing arms, not the acrylic or polyester stabilizing arms of this application. The backbone has similar hydrophobic aromatic groups, and nitrobenzoate groups that can be utilized to interact with the pigment surface. A 2-liter flask was equipped with a thermometer, stirrer, additional funnel, heating mantel, reflux condenser and a means of maintaining a nitrogen blanket over the reactants. The flask was held under nitrogen positive pressure and the following ingredients were employed (Comparative Table 1).

Comparative Table 1

| | Weight |
|---|---|
| | (gram) |
| Portion 1 | |
| Jeffamine M-2005 (Huntsman, Mcintosh, AL) | 200 |
| PNE177 (80% solution in xylene, Chang Chun | 54.88 |
| Plastics Co., Ltd., Taiwan) | |
| p-nitro benzoic acid (p-NBA) | 8.33 |
| Butyl acetate | 150 |
| Portion 2 | |
| Trimethyl benzyl ammonium hydroxide (40% | 3.03 |
| solution in methanol, Aldrich) | |
| Total | 416.24 |

Portion 1 mixture was charged to the flask. The mixture was heated with agitation under the nitrogen blanket until the ingredients were completely dissolved. The Portion 2 was added through the additional funnel. The reaction mixture was heated to reflux and held at reflux temperature for 3 hours. The finished product was cooled and filtered.

The resulting polymer solution was a light yellow clear polymer solution and had a solid content of about 63.81% and a Gardner-Holtz viscosity of F+1/2. The polymer had a 26,184 Mw and a 8,080 Mn based on gel permeation chromatography using polymethylmethacrylate as standard.

### Examples 21-31

### Evaluation of Pigment Dispersants in Solvent Borne Dispersions

The following procedure was utilized to prepare the dispersion samples. To a 2 oz. glass bottle, 15 gm of 0.8 mm glass beads, 15 gm of butyl acetate, 2 gm of pigment and 4 gm of the dispersant copolymer solution were added. The bottle was sealed and agitated on a Red Devil plant shaker for 15 minutes. One drop of the dispersion was placed on a glass plate and protected by a cover glass. The dispersion was observed under the microscope.

The dispersant effectiveness was determined by grinding a mixture of pigment, solvent, and dispersant, with glass beads and observing the dispersion quality under an Olympus microscope, 40×. The well dispersed system would have a uniform appearance and the pigment particles would show vigorous Brownian motion. In contrast, the flocculated systems would have islands of flocculated pigment chunks interspersed with areas of relatively clear solvent. The results were summarized in Table 21 and 22.

TABLE 21

| Pigment | E21 | E22 | E23 | E24 | E25 | E26 | C1 |
|---|---|---|---|---|---|---|---|
| 1 | 0 | 0 | 0 | 1 | 0 | 0 | 0 |
| 2 | 0 | na | na | na | na | 0 | na |
| 3 | na | 0 | 0 | 1 | 0 | na | 0 |
| 4 | 3 | 0 | 0 | 1 | 0 | 0 | 0 |
| 5 | 0 | 0 | 0 | 1 | 0 | 0 | 3 |
| 6 | 0 | 0 | 0 | 1 | 2 | 0 | 0 |
| 7 | 0 | 0 | 0 | 3 | 0 | 0 | 3 |
| 8 | na | 0 | 0 | 0 | 0 | na | 0 |
| 9 | na | 0 | 0 | 0 | 0 | na | 0 |
| 10 | na | 0 | 0 | 0 | 0 | na | 0 |
| 11 | 2 | na | na | na | na | 0 | na |
| 12 | 0 | na | na | na | na | 0 | na |
| 13 | 0 | na | na | na | na | 0 | na |
| 14 | 0 | na | 3 | na | na | 0 | na |
| 15 | 0 | 0 | 0 | 0 | 0 | 0 | 0 |
| 16 | 0 | na | na | na | na | 0 | na |
| 17 | na | 0 | na | 3 | 0 | na | 3 |
| 18 | na | 3 | 0 | 0 | 0 | na | 0 |

TABLE 22

| Pigment | E27 | E28 | E29 | E30 | E31 | C1 |
|---|---|---|---|---|---|---|
| 1 | 0 | 0 | 0 | 0 | 0 | 0 |
| 2 | 0 | na | 0 | 0 | na | na |
| 3 | na | 0 | na | na | 1 | 0 |
| 4 | 0 | 0 | 0 | 0 | 3 | 0 |
| 5 | 0 | 0 | 0 | 0 | 3 | 3 |
| 6 | 0 | 0 | 0 | 0 | 0 | 0 |
| 7 | 0 | 0 | 0 | 0 | 3 | 3 |
| 8 | na | 0 | na | na | 0 | 0 |
| 9 | na | na | na | na | 0 | 0 |
| 10 | na | na | na | na | 0 | 0 |
| 11 | 0 | 0 | 0 | 0 | na | na |
| 12 | 0 | na | na | na | na | na |
| 13 | 0 | na | na | na | na | na |
| 14 | 0 | 0 | 0 | 0 | na | na |
| 15 | 0 | na | 0 | 0 | 0 | 0 |
| 16 | 0 | na | na | na | na | na |
| 17 | na | na | na | na | 0 | 3 |
| 18 | na | na | na | na | 0 | 0 |
| 19 | na | na | 0 | 0 | na | na |
| 20 | na | 0 | 0 | 0 | na | na |
| 21 | na | 2 | na | na | na | na |
| 22 | na | na | 0 | 0 | na | na |

na: Data not available, pigment not tested

### Ratings

0: Deflocculated or dispersed

1: Very slightly flocculated

2: Slightly flocculated

3: Flocculated

### Pigments

1. Sudafast blue 2774 by Sudarshan Chemical Industries Ltd.

2. Palomar blue 248-4828 by Sun Chemical Corp.

3. Palomar blue 248-4816 by Sun Chemical Corp.

4. Parcyanine green P-6100 by Parshwnath Dye Chemical India Ltd.

5. Irgazin yellow L2040 by Sun Chemical Corp.

6. Novoperm orange HL-70 by Colorants Solutions

7. Irgazin Rubine L-4030 by Sun Chemical Colors & Effects

8. Cinquasia magenta L-4540 by Sun Chemical Colors & Effects

9. Perrindo maroon 179 (229-6438) by DCL Corp.

10. Perrindo maroon 179 (229-6442) by DCL Corp.

11. Cinilex DPP red SRIC by Cinic Chemicals LLC

12. Monolite blue 3RXH by Heucotech Ltd.

13. Cinquasia violet L5110 by Sun Chemical Colors & Effects

14. Hostaperm red E4G by Colrants Solutions

15. Sudperm yellow 2935P by Sudarshan Chemical Industries Ltd.

16. Cinquasia red L-3090

17. Hostaperm violet RL-NF by Colors Solutions

18. Raven 5000 Ultra II by Birla Carbon

19. Irgazin red L-3660 HD by Sun Chemical Corp.

20. Sicopal yellow L-1130 by Sun Chemical Colors & Effects

21. Colour black FW-310 by Orion Engineered Carbons

22. Lysopac orange 3620C by Ferro Corp

Based on these test results, the exemplary graft copolymers exhibited excellent performance for certain types of pigments and over a wide range of pigment chemistries in solvent borne systems. The dispersing power is similar to that of the Comparative Example 1. However the acrylic polymer and the polyester polymer of this application will allow a much wider compositional designs to optimize its compatibility with the rest coating composition including solvent(s) and binder polymers. The hydroxyl functionality can also be easily incorporated for crosslinking reactions and best film properties.

It is contemplated that, in various non-limiting embodiments, all combinations of the aforementioned chemistries, ranges, components, method steps, etc. are hereby expressly contemplated for use with one or more of each other even if those combinations are not expressly described in relation to one another or in the same sentence, paragraph, or section above. Moreover, in various non-limiting embodiments, it is contemplated that any one or more of the aforementioned values may be defined as “about” that value.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A polymer that comprises the reaction product of A, B, and C and optionally D and/or E wherein:
A is a polyepoxide that is:
the condensation product of phenol, formaldehyde, and epichlorohydrin;
the condensation product of bisphenol A, formaldehyde, and epichlorohydrin; or
a combination of said condensation products;
B is a polymer that is:
an acrylic polymer with one or two terminal carboxylic acid groups;
a polyester with one carboxylic acid group; or
a combination of said polymers; and
C is an anchoring compound that is:
a primary amine;
a secondary amine;
a monocarboxylic acid;
a cyclic imide; or
a combination thereof;
D is an alkylating agent; and
E is a polyether with a terminal primary amine group.

2. The polymer of claim 1 wherein (B) is the acrylic polymer with one terminal carboxylic acid group and (C) is the monocarboxylic acid.

3. The polymer of claim 1 wherein (B) is the acrylic polymer with two terminal carboxylic acid groups and (C) is the monocarboxylic acid.

4. The polymer of claim 1 wherein (B) is the acrylic polymer terminated with a thioglycolic residue.

5. The polymer of claim 1 wherein (B) is the acrylic polymer terminated with a thiomalic residue.

6. The polymer of claim 1 wherein (B) is an acrylic polymer with one terminal carboxylic acid group comprising the reaction product of methyl methacrylate, butyl methacrylate, ethyl hexyl acrylate, hydroxyethyl methacrylate, and thioglycolic acid.

7. The polymer of claim 1 wherein (B) is an acrylic polymer with two terminal carboxylic acid groups comprising the reaction product of methyl methacrylate, butyl methacrylate, ethyl hexyl acrylate, hydroxyethyl methacrylate, and thiomalic acid.

8. The polymer of claim 1 wherein (B) is an acrylic polymer with two terminal carboxylic acid groups comprising the reaction product of methyl methacrylate, butyl methacrylate, ethyl hexyl acrylate, hydroxyethyl acrylate, and thiomalic acid.

9. The polymer of claim 1 wherein the (C) anchoring compound is the monocarboxylic acid that has the formula R¹COOH wherein R¹ is an aliphatic group having from about 6 to about 8 carbon atoms or an aromatic group having about 6 to about 8 carbon atoms.

10. The polymer of claim 1 wherein the (C) anchoring compound is chosen from nitrobenzoic acid, benzyl amine, methylbenzyl amine, phthalimide, and combinations thereof.

11. The polymer of claim 1 wherein the (A) polyepoxide has the following structure: 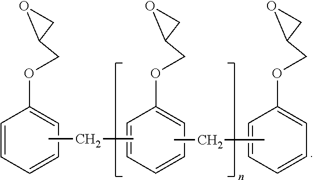
wherein n has an average value of from about 0 to about 10.

12. The polymer of claim 1 wherein the (A) polyepoxide has the following structure: 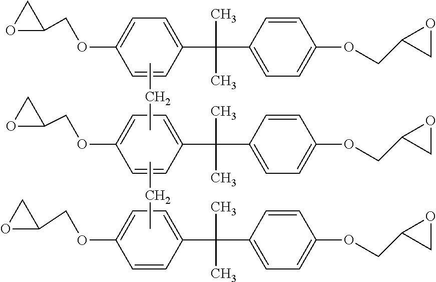
wherein n has an average value of from greater than about 0 and up to about 5.

13. The polymer of claim 1 wherein the moles of epoxy groups of A is approximately equal to the moles of reactive groups of (B+C) wherein B has a single carboxylic acid group, ± up to about 10 mol %.

14. The polymer of claim 1 wherein the moles of epoxy groups of A is approximately equal to the moles of reactive groups of (2B+C) wherein B has two carboxylic acid groups, ± up to about 10 mol %.

15. The polymer of claim 1 wherein the moles of epoxy groups of A is approximately equal to the moles of reactive groups of [(B+C)+2(E)], ± up to about 10 mol %.

16. The polymer of claim 1 wherein C is aromatic.

17. The polymer of claim 1 wherein C comprises the monocarboxylic acid and the monocarboxylic acid is aromatic.

18. The polymer of claim 1 wherein D is methyl-p-toluenesulfonate.

19. The polymer of claim 1 wherein E has the structure: 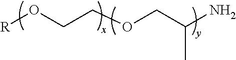
wherein R is methyl, x is 6, and y is 29.

20. A dispersion comprising:
a solvent that is:
water and/or a polar solvent; or
an organic solvent;
a particulate solid; and
the polymer of any one of claim 1.
